(19) United States
(12) Patent Application Publication
(10) Pub. No.: US 2022/0387992 A1
(43) Pub. Date: Dec. 8, 2022

(54) A POINT-OF-CARE TEST CARTRIDGE

(71) Applicant: RADISENS DIAGNOSTICS LTD., Ballincollig (IE)

(72) Inventors: Fabio Miguel Rolo Pereria, Lisboa (PT); Donal Cronin, Kiskeam (IE); David Doolan, Rahan (IE); Yan Zhao, Carrigaline (IE); Eoin O'Nuallain, Greystones (IE)

(73) Assignee: RADISENS DIAGNOSTICS LTD., Ballincollig (IE)

(21) Appl. No.: 17/771,068

(22) PCT Filed: Oct. 23, 2020
(86) PCT No.: PCT/EP2020/079859

§ 371 Date: Apr. 22, 2022

(30) Foreign Application Priority Data
Oct. 25, 2019 (GB) 1915499.6

(51) Int. Cl. B01L 3/00

(52) U.S. Cl. CPC B01L 3/50273; B01L 2400/0409; B01L 2200/0621; B01L 2400/0457; B01L 2200/16; B01L 2300/0803; B01L 2200/0605; B01L 2300/0867

(57) ABSTRACT

The invention provides a microfluidic system comprising a cartridge coupled to a motor and adapted to move a fluid sample to a plurality of locations on the cartridge.

### FIELD

The invention relates to a point-of-care cartridge. In particular the invention relates to a point-of-care diagnostic assay system based on centrifugal microfluidic technology.

### BACKGROUND

Manual processing to determine the biochemical content of various types of samples, is cost-prohibitive in many applications and is also prone to errors. Automation is also cost-prohibitive in many applications, and is inappropriate as currently practiced—using, for example, liquid handling robots—for applications such as point-of-care or doctor's office analysis. As a result, there is an unmet need to provide sample processing for biochemical assays that is less expensive and less prone to error than current automation or manual processing.

Typically it is very difficult to move fluids radially inward using centrifugal microfluidics as the primary means of fluid movement. This can limit/restrict the options available to allow a sequential assay to be performed.

Certain point-of-care diagnostic assay systems based on centrifugal microfluidic technology are quite good at performing the necessary integrated sample preparation and assay measurement steps. Such a centrifugal microfluidic platform with optical detection allows for a variety of assay technologies to be implemented in parallel using a single instrument and disposable cartridges Examples of point-of-care diagnostic assay systems include U.S. Pat. No. 9,182,384B2 (Roche), U.S. Pat. No. 8,415,140B2 (Panasonic), U.S. Pat. No. 8,846,380 (Infopia), U.S. Pat. No. 5,591,643 (Abaxis), U.S. Pat. No. 5,409,665 (Abaxis).

US Patent Publication No. US 2010/074801 describes an analyser comprising a microchip coupled to a motor, where the microchip acquires a liquid sample by means of capillary action. The microchip overcomes the limitation of using capillary action to move a liquid sample by providing a structure which reduces capillary pressure. This is achieved by providing each channel with an adjoining cavity open to atmospheric pressure, which acts so as to prevent an increase in capillary pressure as the fluid length increases. Thus, in one embodiment of the invention, the microchip structure comprises an inlet for collecting a liquid sample, a capillary cavity for holding a predetermined amount of the liquid sample, a single holding chamber having an analytical reagent, a measuring chamber for measuring the mixture of the liquid sample and the reagent, a channel communicating with the holding chamber and the measuring chamber, and a channel connecting the measuring chamber with an atmospheric vent. In use, a liquid sample in the capillary cavity is transferred by centrifugal force into the holding chamber, where it is mixed with the analytical reagent. This mixture is then transferred out of the holding chamber to the inlet of the measuring chamber by capillary force, from where it is transferred into the measuring chamber itself by rotation of the analyser. At the measuring chamber, the concentration of a component of the liquid sample is measured. Accordingly, it will be understood that in this patent document, the microchip structure is configured such that once the holding chamber has delivered the mixture of the single reagent and the liquid sample to the measuring chamber, the mixture cannot be returned to the holding chamber.

US Patent Publication No. US 2015/104814 discloses a sample analysis apparatus for whole blood separation. It comprises a rotatable microfluidic apparatus which comprises a sample chamber for accommodating a sample, a channel that provides a path through which the sample flows, and a valve for opening the channel, which is coupled to a valve driver and a control unit. A separation chamber receives a sample flowing from the sample chamber due to centrifugal force, while a collection chamber for collecting target cells is connected to the separation chamber. In use, the apparatus is rotated to separate the sample into a plurality of layers in the separation chamber according to density gradients of materials in the sample, such as for example a DGM layer, an RBC layer, a WBC layer and a plasma layer. The target material located in the lowermost portion of the separation chamber along with the DGM is then transported to the collection chamber for recovery.

International Patent Publication No. WO 2009/016811 describes a device for analysing a liquid collected from an organism. The device comprises a plurality of individual cuvettes, wherein each cuvette measures a different phase of a reaction. US Patent Publication No. US2017138972 simply describes the use of gravity and centrifugal forces to transfer fluids between three reaction chambers in order to provide multiple washing steps to separate a composite from unbound or unreacted substances.

It is therefore an object to provide an improved point-of-care diagnostic assay systems based on centrifugal microfluidic technology.

### SUMMARY

According to the invention, there is provided, as set out in the appended claims, a microfluidic system comprising:
a cartridge coupled to a motor and adapted to move a fluid sample to a plurality of locations on the cartridge, wherein the cartridge is configured to rotate on an inclined plane with respect to a horizontal plane;
the cartridge comprises:
a reaction chamber, the reaction chamber comprising at least a first zone comprising a single cuvette positioned adjacent to the outer diameter of the cartridge and defining a detection zone configured to allow for optical measurement of each phase of a reaction, and wherein the reaction chamber has at least three zones, the first zone positioned near one end of the reaction chamber, a second zone and a third zone, wherein each of the second zone and the third zone comprise a reagent zone, and wherein the motor and a control module is configured to provide a combination of centrifugal force and gravitational force to move said fluid sample between the at least three zones;
a sample metering chamber configured to receive the fluid sample and meter a pre-defined volume of the sample for transfer to a sample mixing chamber;
a first buffer metering chamber configured to meter a pre-defined first volume of a buffer solution for transfer to the sample mixing chamber;
wherein the sample mixing chamber is coupled to the sample metering chamber and to the first buffer metering chamber and configured to homogenise the sample volume transferred from the sample metering chamber with the first volume of buffer solution transferred from the first buffer metering chamber to create a first sample-diluent mixture; and
a second buffer metering chamber configured to meter a pre-defined second volume of the buffer solution for transfer to the reaction chamber; wherein the second volume of the buffer solution is transferred to the reaction chamber and rehydrated with at least one reagent prior to homogenisation with the first sample-diluent mixture in the reaction chamber so as to create a second sample-diluent mixture.

In one embodiment, the first zone is positioned at a radial extent and at a furthest point from a centre of rotation of the reaction chamber.

In one embodiment, the second zone is positioned radially inward with respect to the first zone and comprises a first reagent spot location R1.

In one embodiment, the second zone is positioned at the same radius as the first zone and comprises a first reagent spot location R1.

In one embodiment, the second zone is connected to the third zone by a siphon.

In one embodiment, the third zone is positioned radially inward with respect to the first zone and comprises a second reagent spot location R2.

In one embodiment, the first buffer solution from the first buffer metering chamber is transferred to the sample mixing chamber prior to the sample volume from the sample metering chamber being transferred to the sample mixing chamber.

In one embodiment, the sample mixing chamber is coupled to the reaction chamber, and wherein the first sample-diluent mixture is transferred from the sample mixing chamber to the reaction chamber for homogenisation with the second buffer solution after the second volume of the buffer solution has been transferred to the reaction chamber and has rehydrated a first reagent in the reagent spot location R1 in the second zone of the reaction chamber and rehydrated a second reagent in the reagent spot location R2 in the third zone of the reaction chamber.

In one embodiment, the sample mixing chamber is incorporated within the second zone of the reaction chamber.

In one embodiment, the sample volume from the sample metering chamber and the first buffer solution from the first buffer metering chamber are transferred to the sample mixing chamber via a channel located at the top of the second zone.

In one embodiment, the sample volume from the sample metering chamber and the first buffer solution from the first buffer metering chamber are transferred to the sample mixing chamber via a channel located in the side of the second zone.

In one embodiment, the second volume of the buffer solution is transferred into the reaction chamber at the first zone of the reaction chamber.

In one embodiment, the second volume of the buffer solution is transferred into the reaction chamber simultaneously with the transfer of the first buffer solution from the first buffer metering chamber to the sample mixing chamber.

In one embodiment, a first reagent in the reagent spot location R1 in the second zone of the reaction chamber is rehydrated by the first sample diluent mixture and homogenised to form a mixture of the first sample-diluent and the first reagent prior to homogenisation with the second volume of the buffer solution in the first zone of the reaction chamber.

In one embodiment, a second reagent in the reagent spot location R2 in the third zone of the reaction chamber is rehydrated by the second volume of the buffer solution and homogenised to form a mixture of the second volume of buffer solution and the second reagent prior to homogenisation with the first sample-diluent mixture in the first zone of the reaction chamber.

In one embodiment, the rehydration of the first reagent in the reagent spot location R1 in the second zone of the reaction chamber is simultaneous with the rehydration of the second reagent in the reagent spot location R2 in the third zone of the reaction chamber.

In one embodiment, the sample metering chamber comprises a plasma separation and sample metering chamber configured to receive the fluid sample and meter a pre-defined volume of the sample and then separate the cellular components from the plasma.

In one embodiment, the system further comprises a sample chamber coupled to the sample metering chamber for receiving the sample for delivery to the sample metering chamber.

In one embodiment, the system further comprises a buffer chamber coupled to the first buffer metering chamber and to the second buffer metering chamber for storing the buffer solution.

In one embodiment, the system further comprises an overflow metering chamber coupled to the buffer chamber for receiving excess buffer from the buffer chamber.

In one embodiment, the cartridge is configured such that no fluid reaches the second zone or third zone when the fluid sample in the first zone is under the influence of the centrifugal force.

In one embodiment, when the cartridge is configured to be stationary or rotate slowly, gravity will influence the fluid and move the fluid towards the second zone or third zone.

In one embodiment, the cuvette comprises a single volume cuvette configured to allow for optical measurement of the buffer solution, the fluid sample and the rehydrated reagents used in each phase of the reaction.

In one embodiment, the system is configured for performing a single immunoturbidimetric or enzyme-based clinical chemistry assay.

According to another aspect of the invention, there is provided a microfluidic system comprising:
a cartridge coupled to a motor and adapted to move a fluid sample to a plurality of locations on the cartridge, wherein the cartridge is configured to rotate on an inclined plane with respect to a horizontal plane;
the cartridge comprises:
at least a first reaction chamber and a second reaction chamber, each reaction chamber comprising at least a first zone comprising a single cuvette positioned adjacent to the outer diameter of the cartridge and defining a detection zone configured to allow for optical measurement of each phase of a reaction, and wherein at least the first reaction chamber has at least three zones, the first zone positioned near one end of the reaction chamber, a second zone positioned proximal to the first zone and a third zone positioned near the other end of the reaction chamber, wherein each of the second zone and the third zone comprise a reagent zone, and wherein the motor and a control module is configured to provide a combination of centrifugal force and gravitational force to move said fluid sample between the at least three zones;
a sample metering chamber configured to receive the fluid sample and meter a pre-defined volume of the sample for transfer to a sample mixing chamber;
a first buffer metering chamber configured to meter a pre-defined first volume of a buffer solution for transfer to the sample mixing chamber;
wherein the sample mixing chamber is coupled to the sample metering chamber and to the first buffer metering chamber and configured to homogenise the sample volume transferred from the sample metering chamber with the first volume of buffer solution transferred from the first buffer metering chamber to create a first sample-diluent mixture, and wherein a first portion of the first sample-diluent mixture is to be transferred to the first reaction chamber and a second portion of the first sample-diluent mixture is to be transferred to the second reaction chamber; and
a second buffer metering chamber configured to meter a pre-defined second volume of the buffer solution for transfer to the first reaction chamber; wherein the second volume of the buffer solution is transferred to the first reaction chamber for homogenisation with the first sample-diluent mixture so as to create a second sample-diluent mixture.

This system accordingly enables at least two single volume cuvettes to be configured to allow for optical measurement of two different sample-diluent ratios and rehydrated reagents.

In one embodiment the first sample-diluent mixture is transferred from the sample mixing chamber to the first reaction chamber after the second volume of the buffer solution has been transferred to the first reaction chamber and has rehydrated the reagents in the first reaction chamber.

In one embodiment the system further comprises a rehydration chamber coupled between the second buffer metering chamber and the first reaction chamber, wherein the rehydration chamber is configured to rehydrate a reagent located in the rehydration chamber with the second volume of the buffer solution transferred from the second buffer metering chamber and to transfer the volume of rehydrated reagent to the first reaction chamber.

In one embodiment the first sample-diluent mixture is transferred from the sample mixing chamber to the first reaction chamber simultaneously with the transfer of the volume of rehydrated reagent to the first reaction chamber.

In one embodiment the system further comprises a distribution channel coupled between the sample mixing chamber and the two or more reaction chambers, wherein the distribution channel is configured to deliver the first sample-diluent mixture from the sample mixing chamber downstream to each of the two or more reaction chambers in sequence.

In one embodiment the system further comprises a diluted sample metering chamber coupled between the distribution channel and the first reaction chamber, wherein the diluted sample metering chamber is configured to meter a pre-defined volume of the first sample-diluent mixture for transfer to the first reaction chamber.

In one embodiment the system further comprises an intermediate metering chamber coupled between the distribution channel and the second reaction chamber configured to meter a pre-defined volume of the first sample-diluent mixture for transfer to the second reaction chamber.

In one embodiment the system further comprises a reagent located in the intermediate metering chamber, wherein the intermediate metering chamber is configured to rehydrate the reagent with the metered volume of the first sample-diluent mixture prior to transfer to the second reaction chamber.

In one embodiment the system further comprises a sample dilution overflow chamber coupled to the distribution channel for receiving the first sample-diluent mixture which remains after delivery to the two or more reaction chambers.

In one embodiment the sample metering chamber comprises a plasma separation and sample metering chamber configured to receive the fluid sample and meter a pre-defined volume of the sample and then separate the cellular components from the plasma.

In one embodiment the system further comprises a sample chamber coupled to the sample metering chamber for receiving the sample for delivery to the sample metering chamber.

In one embodiment the system further comprises a buffer chamber coupled to the first buffer metering chamber and to the second buffer metering chamber for storing the buffer solution.

In one embodiment the system further comprises an overflow metering chamber coupled to the buffer chamber for receiving excess buffer from the buffer chamber.

In one embodiment the first zone is positioned at a radial extent and at a furthest point from a centre of rotation of the reaction chamber.

In one embodiment the second zone is positioned radially inward with respect to the first zone and comprises first reagent spot location R1.

In one embodiment the third zone is positioned between the most radially inward end of the reaction chamber and the radial inward position of the second zone and the third zone comprises a second reagent spot location R2.

In one embodiment the cartridge is configured such that no fluid reaches the second zone or third zone when the fluid sample is under the influence of the centrifugal force.

In one embodiment the cartridge is configured to be stationary or rotate slowly, gravity will influence the fluid and move the fluid towards the second zone or third zone.

In one embodiment each cuvette comprises a single volume cuvette configured to allow for optical measurement of the buffer solution, the fluid sample and the rehydrated reagents used in each phase of the reaction.

In one embodiment the system is configured for performing two or more immunoturbidimetric or enzyme-based clinical chemistry assays.

According to another aspect of the invention, there is provided a microfluidic system comprising:
a cartridge coupled to a motor and adapted to move a fluid sample to a plurality of locations on the cartridge, wherein the cartridge is configured to rotate on an inclined plane with respect to a horizontal plane;
the cartridge comprises a reaction chamber having at least three zones, a first zone positioned near one end of the reaction chamber to define a detection zone, a second zone positioned proximal to the first zone and a third zone positioned near the other end of the reaction chamber, wherein each of the second zone and the third zone comprise a reagent zone; and the motor and a control module is configured to provide a combination of centrifugal force and gravitational force to move said fluid sample between the at least three zones, wherein the first zone comprises a single cuvette positioned adjacent to the outer diameter of the cartridge and configured to allow for optical measurement of each phase of a reaction.

In one embodiment the first zone is positioned at a radial extent and at a furthest point from the centre of rotation of the reaction chamber.

In one embodiment the second zone is positioned radially inward with respect to the first zone and comprises first reagent spot location R1.

In one embodiment wherein the third zone is positioned between the most radially inward end of the reaction chamber and the radial inward position of the second zone and the third zone comprises a second reagent spot location R2.

In one embodiment there is provided a first separate rehydration chamber to rehydrate an R1 reagent (R1-X) or a different reagent.

In one embodiment there is provided a buffer metering chamber coupled to the first separate rehydration chamber configured to meter a pre-defined volume of buffer solution for transfer to the first separate rehydration chamber to rehydrate the R1 reagent (R1-X) or a different reagent in the rehydration chamber.

In one embodiment there is provided a second separate rehydration chamber to rehydrate an R2 reagent (R2-Y) or a different reagent.

In one embodiment there is provided two or more reaction chambers.

In one embodiment the reaction chamber comprises at least one of an oblong shape; a circular shape, a square shape; a zigzag shape or a cross shape.

In one embodiment the first zone comprises a cuvette and is positioned adjacent to the outer diameter of the cartridge.

It will be appreciated the cartridge of the invention provides a number of advantages over the prior art:
Overall cartridge concept uses gravitational and centrifugal microfluidic methods
Single volume reaction, i.e. removes the need for any or all of the steps including: dilution, aliquoting or metering of reagents which simplifies operation and potentially improves test precision
Sequential optical measurements in a single cuvette for each assay phase to improve precision
Location of R1 and R2 reagents for sequential rehydration
Homogenous mixing of sample and buffer
Ability to carry out an optical measurement on buffer and/or sample
Cuvette filling using centrifugal force to provide an even liquid meniscus for consistent optical interrogation
Optical measurement of the assay reaction using static or dynamic (while rotating) methods

In one embodiment the first detection zone comprises a cuvette and positioned at the radial extent of the V shaped reaction chamber.

In one embodiment the V shaped chamber extends radially inward on two sides to create two zones that can be independently filled with fluid to define the second zone and third zone.

In one embodiment the second and/or third zone comprises a reagent storage and/or rehydration zones.

In one embodiment the second and/or third zone comprises a region adapted to be optically interrogated.

In one embodiment the cartridge is positioned and configured to rotate at a velocity such that a combination of centrifugal force and gravity moves the fluid sample radially outward and inward respectively.

In one embodiment the cartridge rotates at a velocity such that the relative centrifugal force (RCF) is greater than gravity, and the fluid sample can be moved radially outward on the cartridge.

In one embodiment the centrifugal force ensures that no fluid reaches the second zone or third zone.

In one embodiment the cartridge is stationary or rotating slowly, gravity will influence the fluid and move the fluid towards the second zone or third zone.

In one embodiment the cartridge is rotated or agitated on an inclined plane with respect to a horizontal plane to create a downward slope for the fluid sample to flow under the influence of gravity.

In one embodiment, the cartridge is further configurable to be agitated to overcome any effects of surface tension that may prevent the fluid from flowing under the influence of gravity.

In one embodiment the cartridge rotates on an inclined plane at an angle of θi from the horizontal plane and wherein the angle is between 10° to 60°.

In one embodiment a buffer reservoir is positioned close to the centre of rotation of the cartridge and a module configured for applying a sample directly to the cartridge.

In one embodiment the dominant force on the fluid sample meniscus is the centrifugal force such that the centrifugal force is parallel to the upper and lower surface of the first detection zone to provide a meniscus evenly on both surfaces.

In one embodiment the second zone comprises a dried reagent.

In one embodiment the third zone comprises a dried reagent.

In one embodiment the dried reagent remains intact until the second or third zones are rehydrated with the fluid sample and a buffer solution.

In one embodiment the dried reagent can be spotted in singular or multiple spots in said second and/or third zones.

In one embodiment the second or third zone comprises multiple dried reagents.

In one embodiment the cuvette comprises a single volume cuvette configured to allow for optical measurement of the buffer solution, the fluid sample and the rehydrated reagents used in each phase of an assay.

In one embodiment the system is configured for performing an immunoturbidimetric or an enzyme-based clinical chemistry assay.

In one embodiment there is provided a sample metering chamber configured to receive the fluid sample and meter a pre-defined volume of the sample and a buffer metering chamber configured to meter a pre-defined volume of buffer solution.

In one embodiment there is provided a sample mixing chamber coupled to the sample metering chamber and coupled to the buffer metering chamber, wherein the sample mixing chamber is configured to mix the sample volume transferred from the sample metering chamber with the volume of buffer solution transferred from the buffer metering chamber to form a dilution of the sample.

In one embodiment there is provided a diluted sample metering chamber coupled between the sample mixing chamber and the reaction chamber, wherein the diluted sample metering chamber is configured to meter a pre-defined volume of the dilution of the sample for transfer to the reaction chamber.

In one embodiment there is provided a reaction chamber coupled to the diluted sample metering chamber.

In one embodiment there is provided two or more reaction chambers each reaction chamber comprising at least the first zone, and wherein at least one reaction chamber has the at least three zones.

In one embodiment there is provided a sample dilution chamber for mixing the fluid sample and a buffer solution, and a distribution channel coupled between the sample dilution chamber and the two or more reaction chambers, wherein the distribution channel is configured to deliver a diluted sample from the sample dilution chamber downstream to each of the two or more reaction chambers in sequence.

In one embodiment there is provided a delivery channel associated with each reaction chamber, wherein the diluted sample is delivered from the distribution channel to each reaction chamber by means of its delivery channel.

In one embodiment there is provided an overflow chamber coupled to the distribution channel for receiving the diluted sample which remains after delivery to the two or more reaction chambers.

In one embodiment there is provided a buffering chamber coupled to the distribution channel, wherein the buffering chamber is configured to prevent cross contamination between two or more of the reaction chambers.

In one embodiment there is provided an intermediate sample metering chamber coupled between one of the reaction chambers and its delivery channel, wherein the intermediate sample metering chamber is configured to prevent cross-contamination between the two or more reaction chambers.

In one embodiment there is provided an intermediate chamber coupled between each delivery channel and its reaction chamber.

In one embodiment each intermediate chamber comprises a metering chamber and an overflow chamber configured such that the metering chamber is filled with diluted sample from the distribution channel until the centrifugal pressure applied to the delivery channel is equal to the pressure in the overflow chamber.

In one embodiment there is provided a buffering chamber coupled to the distribution channel, wherein the buffering chamber comprises a first section and a second section linked by a capillary channel.

In a further embodiment there is provided a microfluidic system comprising:
a cartridge coupled to a motor and adapted to move a fluid sample to a plurality of locations on the cartridge, wherein the cartridge is configured to rotate on an inclined plane with respect to a horizontal plane;
the cartridge comprises a chevron shaped or substantially V shaped reaction chamber having at least three zones, wherein a first zone is positioned near the apex of the V shaped reaction chamber to define a detection zone, a second zone positioned near a first end of the V shaped reaction chamber and a third zone positioned near a second end of the V shaped reaction chamber, wherein each of the second zone and the third zone comprise a reagent zone; and
   the motor and a control module is configured to provide a combination of centrifugal force and gravitational force to move said fluid sample between the at least three zones

In another embodiment there is provided, a microfluidic system comprising:
a cartridge coupled to a motor and adapted to move a fluid sample to a plurality of locations on the cartridge;
the cartridge comprises a chevron shaped or substantially V shaped reaction chamber having at least three zones, wherein a first zone is positioned near the apex of the V shaped reaction chamber to define a detection zone, a second zone positioned near a first end of the V shaped reaction chamber and a third zone positioned near a second end of the V shaped reaction chamber; and
the motor and a control module is configured to provide a combination of centrifugal force and gravitational force to move said fluid sample between the at least three zones.

In yet another embodiment there is provided, a microfluidic system comprising:
a cartridge coupled to a motor and adapted to move a fluid sample to a plurality of locations on the cartridge, wherein the cartridge is configured to rotate on an inclined plane with respect to a horizontal plane;
the cartridge comprises a reaction chamber having at least three zones, a first zone positioned near one end of the reaction chamber to define a detection zone, a second zone positioned proximal to the first zone and a third zone positioned near the other end of the reaction chamber, wherein each of the second zone and the third zone comprise a reagent zone; and
the motor and a control module is configured to provide a combination of centrifugal force and gravitational force to move said fluid sample between the at least three zones.

### BRIEF DESCRIPTION OF THE DRAWINGS

The invention will be more clearly understood from the following description of an embodiment thereof, given by way of example only, with reference to the accompanying drawings, in which:—

FIG. 1 is a flow chart illustrating a number of sequential steps required to transfer a 2-step dried reagent assay onto a self-contained/single-use/disposable point-of-care (POC) cartridge;

FIG. 2 shows a cartridge design embodiment to perform the assay sequence according to a first embodiment of the invention;

FIG. 3 illustrates a normal view of the cartridge surface showing reagent rehydration;

FIG. 4 illustrates a chevron shaped or substantially V shaped reaction chamber having at least three zones, according to one embodiment;

FIG. 5 shows a side view of the cartridge mounted on a motor platform during operation;

FIG. 6, FIG. 7 and FIG. 8 illustrate the benefit of filling the cuvette by centrifugal force;

FIG. 9 shows a cartridge design embodiment to perform the assay sequence according to an embodiment of the invention which uses a second dried reagent spot in the third reagent zone;

FIG. 10 shows a cartridge design embodiment to perform the assay sequence illustrated in the flow chart of FIG. 1;

FIG. 11a illustrates an alternative cartridge design to FIG. 10 incorporating an additional rehydration chamber;

FIG. 11b shows a cartridge design embodiment based on FIG. 11a where an additional rehydration chamber is used;

FIG. 12 illustrates another cartridge design and a variation of the embodiment shown in FIG. 11a;

FIG. 13 illustrates another cartridge design and a variation of the embodiments shown FIGS. 11a and 12;

FIG. 14a illustrates another embodiment showing a plurality of reaction chambers on a single cartridge design;

FIG. 14b shows a cartridge design embodiment based on FIG. 14a;

FIG. 14c shows a cartridge design embodiment based on FIG. 14a;

FIG. 15 illustrates another cartridge design and a variation of the described embodiments of FIG. 11b and FIG. 14c;

FIG. 16 illustrates another cartridge design and a variation of the described embodiments of FIG. 11b, FIG. 14c and FIG. 15;

FIG. 17 illustrates one embodiment of the cartridge design of FIG. 16; and

FIG. 18 illustrates another embodiment of the cartridge design of FIG. 16.

### DETAILED DESCRIPTION OF THE DRAWINGS

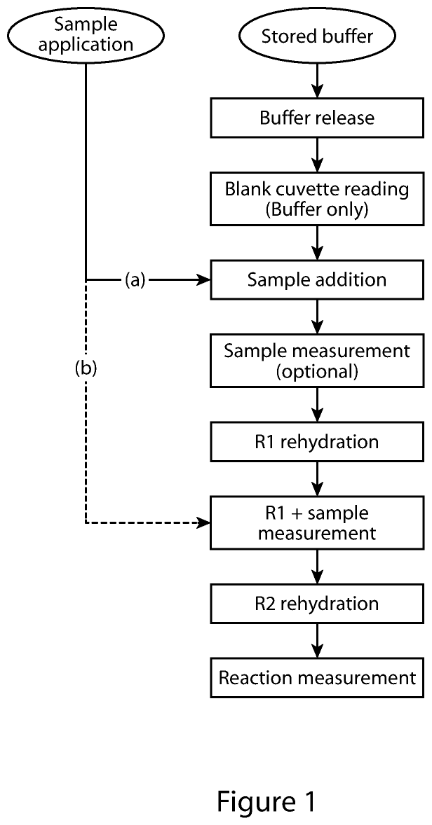

FIG. 1 illustrates a number of sequential steps required to transfer a 2-step dried reagent assay onto a self-contained/single-use/disposable point-of-care (POC) cartridge. This sequence can be applied to immunoturbidimetric and enzyme-based clinical chemistry assays that require two-step addition & rehydration of reagents R1 and R2 to complete a test measurement. A similar test sequence can be used for a 1 step assay where reagents R1 or R2 are used only.

The POC cartridge can include a buffer reservoir and will have a means to apply a sample (for example whole blood, plasma, serum) to the cartridge. The cartridge may contain dried, immobilised reagents (R1 and R2) stored in specific locations on the cartridge that can be rehydrated independently. Depending on where the sample is added in the sequence (option (a) or (b) in FIG. 1), R1 can be rehydrated by either diluted sample (buffer+sample) or buffer only. R2 is then rehydrated by this same fluid volume.

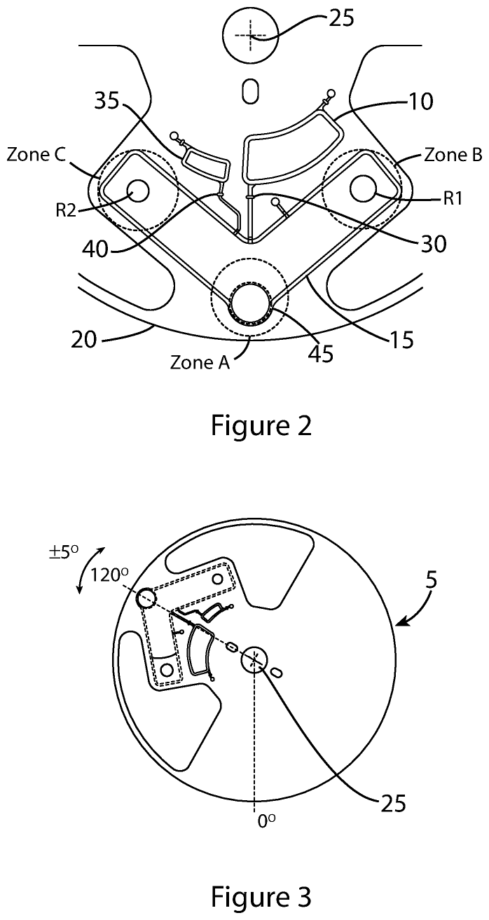

FIG. 2 shows a cartridge design embodiment to perform the assay sequence illustrated in the flow chart of FIG. 1, according to a first embodiment of the invention. The cartridge design employs a combination of centrifugal and gravitational microfluidics to move fluids to multiple locations on the cartridge. The cartridge 5 includes a buffer reservoir 10 that will sit at or close to the centre of rotation 25. There is also provided a means for applying a sample directly to the cartridge (not shown in FIG. 2). The cartridge, layout described in more detail below, resolves the following problems:
Single volume reaction, i.e. removes the need for any or all of the steps including: dilution, aliquoting or metering of reagents which simplifies operation and potentially improves test precision
Sequential optical measurements in a single cuvette for each assay phase to improve precision
Location of R1 and R2 reagents in distinct zones for sequential rehydration
Homogenous mixing of sample and buffer and the ability to carry out an optical measurement on buffer and/or sample

Referring to FIG. 2 the cartridge 5 comprises a chevron shaped or substantially V shaped reaction chamber 15 having at least three zones. A first zone is positioned near the apex of the V shaped reaction chamber to define a detection zone. A second zone is positioned near a first end of the V shaped reaction chamber and a third zone is positioned near a second end of the V shaped reaction chamber. The motor and a control module is configured to provide a combination of centrifugal force and gravitational force to move said fluid sample between the three zones.

In operation, centrifugal force is used to control the delivery of a stored buffer from its reservoir 10 and/or subsequent buffer chambers prior to being delivered to the reaction chamber 15. The reaction chamber 15 is sized such that it is much greater than the buffer reaction volume that will be used. The reaction chamber 15 incorporates three distinct zones: A) cuvette detection zone, B) R1 reagent zone and C) R2 reagent zone. The cuvette 45 is located at the radial extent of the reaction chamber 15 (typically close to the cartridge outer diameter 20). The chamber extends radially inward on two sides to create two zones that can be independently filled with fluid for the R1 and R2 reactions. It is beneficial that each zone is sized such that when occupied by buffer they can hold the entire volume within the zone, i.e. the volume of zone A, B or C is equal or greater than the buffer volume and the entire reaction chamber 15 is at a minimum of 3× greater than the buffer volume.

Typically it is very difficult to move fluids radially inward using centrifugal microfluidics as the primary means of fluid movement. This can limit/restrict the options available to allow a sequential assay to be performed. To overcome this problem, a combination of centrifugal force and gravity are used to move fluids radially outward and inward respectively. When the cartridge 5 rotates at velocities where the relative centrifugal force (RCF) is much greater than gravity, centrifugal forces will dominate and fluid can be moved radially outward on the cartridge. When the cartridge 5 is stationary or rotating slowly, gravity will still influence the fluid and can be used to move the fluid. To take advantage of this, the cartridge 5 is rotated on an inclined plane (from the horizontal) such that the cartridge 5 can be positioned statically to create a downward slope for fluid to flow. This method can be employed to move fluids radially inward on the cartridge when it is aligned in particular orientations. The flow of fluid under gravity can also be aided by gentle agitation/shaking to overcome any effects of surface tension that may prevent fluids from flowing.

In FIG. 2, the buffer stored centrally in the buffer chamber is delivered to the reaction chamber 15 (via a capillary valve 30) by centrifugal force. This buffer volume fills the cuvette 45 (Zone A) and a blank measurement of buffer can be performed. Next, the applied sample in the sample chamber 35 is also delivered by centrifugal force (via a capillary valve 40) into the reaction chamber 15 (Zone A) where it is mixed with the buffer. It is appreciated that the sample chamber may include additional sample processing steps such as but not limited to plasma separation or whole blood lysis. A sample measurement can be taken at this point in the test sequence if required (may be used as an internal control).

During both buffer and sample delivery steps, the centrifugal force ensures that no fluid reaches Zones B or C and the dried reagents remain intact until R1 and R2 are to be rehydrated.

The cartridge 5 is then aligned to allow the fluid within Zone A to flow to Zone B under gravity (aided by gentle agitation if required). The sample and buffer suspension wets reagent R1 and begins rehydrating it. The rehydration continues for a defined period of time until full rehydration has been achieved. This rehydration can be aided by mixing/agitation. When fully rehydrated, centrifugal force is used to move the sample, buffer and R1 suspension back to the cuvette 45 (Zone A) where a calibration measurement can be performed on this suspension. FIG. 3 illustrates a normal view of the cartridge surface showing reagent rehydration.

Similar to the rehydration of reagent R1, the cartridge 5 is then orientated to allow the fluid to flow from the cuvette 45 to Zone C where the R2 reagent(s) are wetted by the buffer, sample and R1 suspension. Again, rehydration continues for a defined period of time until both dried reagents are fully rehydrated. The rehydration can again be aided by mixing agitation on the cartridge 5. Finally, the entire fluid volume is returned to the cuvette 45 (Zone A) where the final reaction can be monitored. It is worth noting that reagents R1 and/or R2 can be spotted in singular or multiple spots.

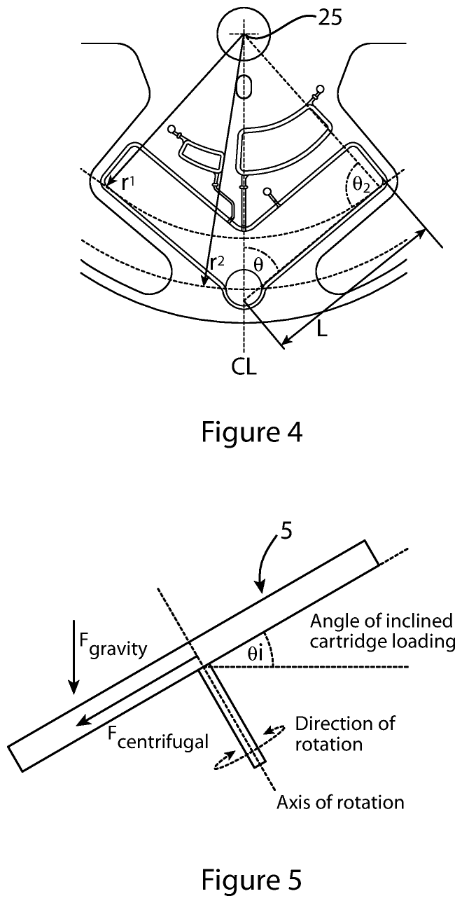

Illustrated in FIG. 4 are the radii r1 and r2, the angles θ and θ2 and the length L. The reagent spot locations are not shown for simplicity. r1 is the radius at which the distal wall of the reaction chamber in Zone B and Zone C is located while r2 is the radius at which the cuvette is centered in Zone A. The length L is the length of distal wall of the reaction chamber. θ is the angle at which the wall is defined from the centerline (created through the center of rotation 25 and the center of the cuvette) and θ2 is the angle formed between a notional centerline (through the center of rotation) and the distal wall of the reaction chamber at the extent of the chamber. In this embodiment, the reaction chamber is designed symmetrically about the centerline which can be advantageous but is not a requirement and can be designed asymmetrically. It is preferred that the length of the chamber wall (L) does not extend beyond a point such that the angle θ2 is <90°. When the angle θ2 remains ≥90°, this ensures that the radius r1<r2. Under centrifugal force, this allows fluid to return to the cuvette region at r2 since fluid will tend towards the outer radius.

FIG. 5 shows a side view of the cartridge 5 mounted during operation. The cartridge rotates on an inclined plane at an angle of θi (from horizontal). It is ideal that the inclined angle is between 10° to 60°, preferably 30° (provides sufficient gravity and is beneficial for ease of use). Also highlighted are the directions of the centrifugal force and gravity force. The centrifugal force will always be perpendicular to the axis of rotation, i.e. acts in the radial direction (outward) upon rotation.

For example FIG. 3 shows the cartridge rotated to align at an angle of 120° from a zero position. In one embodiment the zero position can be the lowest point of the cartridge plane with respect to the center of rotation to enable operation. In this location, Zone B can be filled with fluid from Zone A since the cartridge is secured on an inclined plane. After reagent rehydration is performed in Zone B, the fluid can be returned to Zone A (cuvette) for detection by centrifugal or gravity driven methods. However, it is highly preferred that centrifugal force is used to achieve consistent filling of the cuvette.

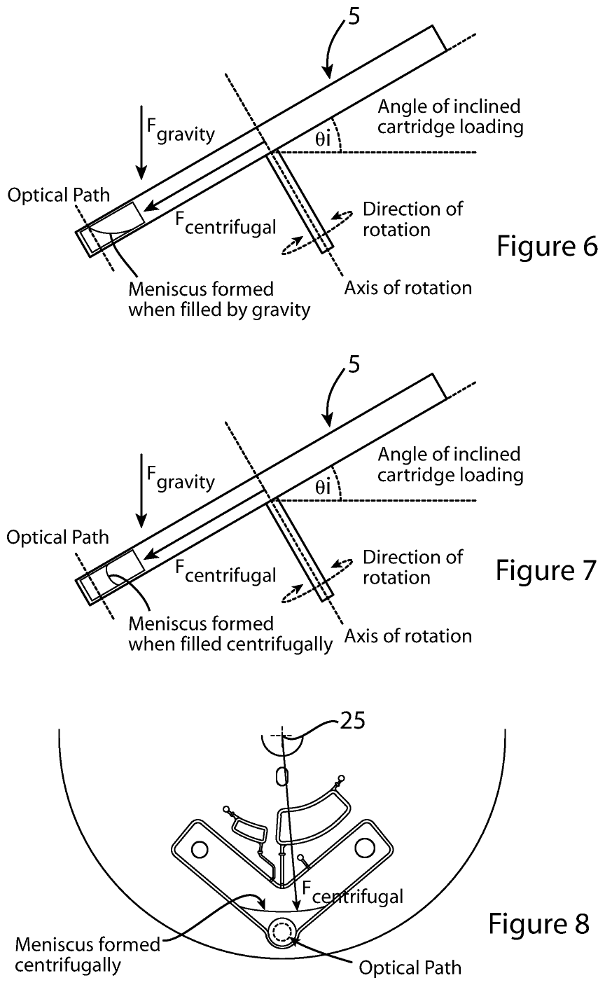

FIG. 6, FIG. 7 and FIG. 8 illustrate the benefit of filling the cuvette by centrifugal force as opposed to gravity. The optical detection path is normal to the cartridge surface and so is aligned perpendicular to the angle at which the cartridge 5 is inclined. It is important that the cuvette is filled entirely and consistently by a column of fluid to ensure that there are no optical irregularities arising from partially or badly filled cuvettes. If the cuvette is filled by gravity, the dominant force on the liquid meniscus is gravity and so the meniscus shape will be uneven and is likely to wet the upper and lower cuvette surfaces to varying levels (FIG. 6). However, when filled by centrifugal force (FIG. 7), the dominant force on the liquid meniscus is the centrifugal force. Since the centrifugal force is parallel to the upper and lower surface of the cuvette, the meniscus is formed evenly on both surfaces. This ensures that the detection zone will always be sufficiently filled with fluid during optical measurements. FIG. 8 shows the formed meniscus when viewing the cartridge normal to the axis of rotation. The optical path (which may be larger or smaller than shown) can be filled entirely by centrifugal force. Additionally, filling by centrifugal force also ensures that the cuvette is entirely free from air by preventing any trapped air bubbles forming within the optical window.

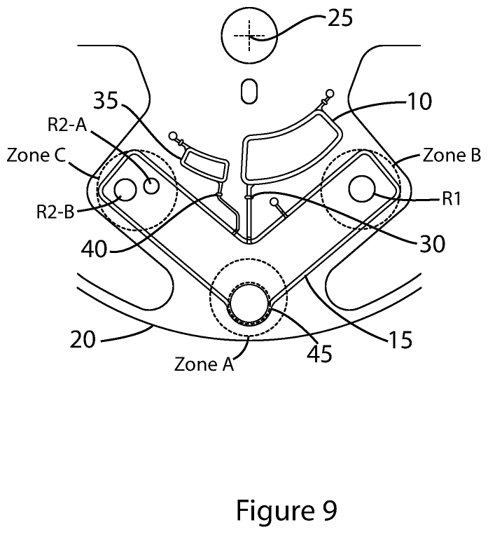

FIG. 9 shows a cartridge design embodiment to perform the assay sequence according to an embodiment of the invention which uses a second dried reagent spot in the third reagent zone. In FIG. 9, the buffer stored centrally in the buffer chamber 10 is delivered to the reaction chamber 15 (via a capillary valve 30) by centrifugal force. This buffer volume fills the cuvette 45 (Zone A) and a blank measurement of buffer can be performed. Next, the applied sample in the sample chamber 35 is also delivered by centrifugal force (via a capillary valve 40) into the reaction chamber 15 (Zone A) where it is mixed with the buffer. A sample measurement can be taken at this point in the test sequence if required (may be used as an internal control). During both buffer and sample delivery steps, the centrifugal force ensures that no fluid reaches Zones B or C and the dried reagents remain intact until R1 and R2 are to be rehydrated.

The cartridge is then aligned to allow the fluid within Zone A to flow to Zone B under gravity (aided by gentle agitation if required). The sample and buffer suspension wets reagent R1 and begins rehydrating it. The rehydration continues for a defined period of time until full rehydration has been achieved. This rehydration can be aided by mixing/agitation. When fully rehydrated, centrifugal force is used to move the sample, buffer and R1 suspension back to the cuvette 45 (Zone A) where a calibration measurement can be performed on this suspension.

Similar to the rehydration of reagent R1, the cartridge is then orientated to allow the fluid to flow from the cuvette 45 to Zone C where the R2 reagents (split in to reagents R2-A and R2-B) are wetted by the buffer, sample and R1 suspension. Again, rehydration continues for a defined period of time until both dried reagents are fully rehydrated. The rehydration can again be aided by mixing agitation on the cartridge. Finally, the entire fluid volume is returned to the cuvette 45 (Zone A) where the final reaction can be monitored. Reagents R1 and/or R2 can be spotted in singular or multiple spots.

In the context of the present invention the term ‘zone’ can be interpreted as an area within a chamber than can be wholly filled with fluid without wetting or filling neighbouring zones within the same chamber. In practice, this means that the volume of fluid used is typically much less than the total volume of the chamber and is only sufficient to occupy a single zone at any given time. The fluid is then manipulated between each zone by centrifugal or gravitational force. Each zone can be further distinguished or protected from neighbouring zones by physical barriers incorporated in the shape and design of the reaction chamber.

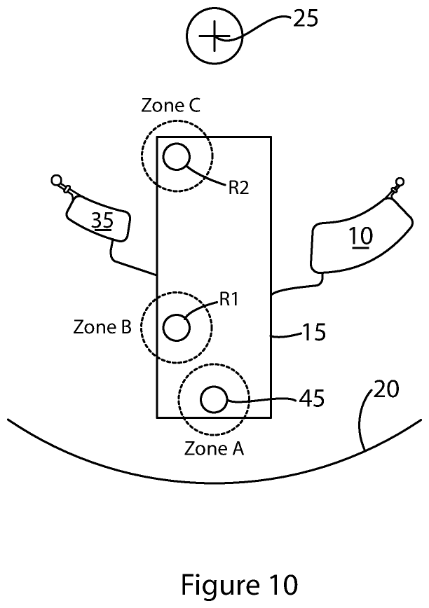

FIG. 10 shows a cartridge design embodiment to perform the assay sequence illustrated in the flow chart of FIG. 1, according to one embodiment of the invention. The cartridge design employs a combination of centrifugal and gravitational microfluidics to move fluids to multiple locations on the cartridge. The cartridge 5 includes a buffer reservoir 10 that will sit at or close to the centre of rotation 25. There is also provided a means for applying a sample directly to the cartridge.

The cartridge comprises a reaction chamber 15 having at least three zones. The reaction chamber 15 as shown is substantially oblong in the radial direction but it is understood that the shape can be modified for optimal performance such as elliptical, circular, zig-zag or other desired shape to accommodate the three zones. The reaction chamber 15 may also have additional mechanical features (not shown) to better distinguish the individual zones in operation. For example, the centre of the chamber may have a restriction in width and/or depth in relation to either end of the reaction chamber.

A first zone A is positioned at the radial extent (i.e. furthest from the centre of rotation 25) of the reaction chamber 15 and defines the detection zone containing the cuvette 45 for optical interrogation of fluid. A second zone B is positioned radially inward of Zone A and contains the first reagent spot location R1. A third zone C can be positioned at the most radially inward end of the reaction chamber 15 and contains a second reagent spot location R2. It will be appreciated that the third zone can also be positioned in the same radial position as the second zone if required. The motor and a control module is configured to provide a combination of centrifugal force and gravitational force to move said fluid sample between the three zones.

In operation, centrifugal force is used to control the delivery of a stored buffer from its reservoir 10 and/or subsequent buffer chambers prior to being delivered to the reaction chamber 15. The reaction chamber 15 is sized such that it is much greater than the buffer reaction volume that will be used. The reaction chamber 15 incorporates three distinct zones: A) cuvette detection zone, B) R1 reagent zone and C) R2 reagent zone. The cuvette 45 is located at the radial extent of the reaction chamber 15 (typically close to the cartridge outer diameter 20). The chamber is dimensioned to allow for the creation of two zones that can be independently filled with fluid for the R1 and R2 reactions. It is beneficial that each zone is sized such that when occupied by buffer they can hold the entire volume within the zone, i.e. the volume of zone A, B or C is equal or greater than the buffer volume and the entire reaction chamber 15 is preferably at a minimum of 3× greater than the buffer volume.

Typically it is very difficult to move fluids radially inward using centrifugal microfluidics as the primary means of fluid movement. This can limit/restrict the options available to allow a sequential assay to be performed. To overcome this problem, a combination of centrifugal force and gravity are used to move fluids radially outward and inward respectively. When the cartridge 5 rotates at velocities where the relative centrifugal force (RCF) is much greater than gravity, centrifugal forces will dominate and fluid can be moved radially outward on the cartridge. When the cartridge 5 is stationary or rotating slowly, gravity will still influence the fluid and can be used to move the fluid. To take advantage of this, the cartridge 5 is rotated on an inclined plane (from the horizontal) such that the cartridge 5 can be positioned statically to create a downward slope for fluid to flow. This method can be employed to move fluids radially inward on the cartridge when it is aligned in particular orientations. The flow of fluid under gravity can also be aided by gentle agitation/shaking to overcome any effects of surface tension that may prevent fluids from flowing.

In FIG. 10, the buffer stored centrally in the buffer chamber 10 is delivered to the reaction chamber 15 by centrifugal force. This buffer volume fills the cuvette 45 (Zone A) and a blank measurement of buffer can be performed. Next, the applied sample in the sample chamber 35 is also delivered by centrifugal force into the reaction chamber 15 (Zone A) where it is mixed with the buffer. It is appreciated that the sample chamber may include additional sample processing steps such as but not limited to plasma separation or whole blood lysis. A sample measurement can be taken at this point in the test sequence if required (may be used as an internal control). During both buffer and sample delivery steps, the centrifugal force ensures that no fluid reaches Zones B or C and the dried reagents remain intact until R1 and R2 are to be rehydrated.

The cartridge 5 is then aligned to allow the fluid within Zone A to flow to Zone B under gravity (aided by gentle agitation if required). The sample and buffer suspension wets reagent R1 and begins rehydrating the reagent. The rehydration continues for a defined period of time until full rehydration has been achieved. This rehydration can be aided by mixing/agitation. When fully rehydrated, centrifugal force is used to move the sample, buffer and R1 suspension back to the cuvette 45 (Zone A) where a calibration measurement can be performed on this suspension.

Similar to the rehydration of reagent R1, the cartridge 5 is then orientated to allow the fluid to flow from the cuvette 45 to Zone C where the R2 reagent(s) are wetted by the buffer, sample and R1 suspension. Again, rehydration continues for a defined period of time until both dried reagents are fully rehydrated. The rehydration can again be aided by mixing agitation on the cartridge 5. Finally, the entire fluid volume is returned to the cuvette 45 (Zone A) where the final reaction can be monitored. It is worth noting that reagents R1 and/or R2 can be spotted in singular or multiple spots.

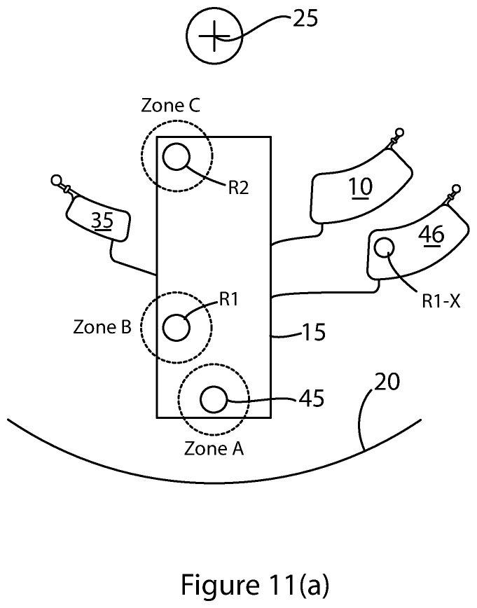

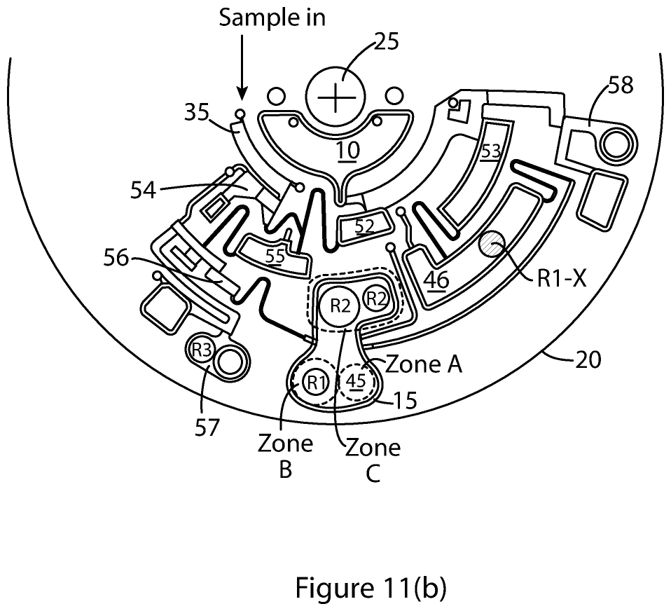

FIG. 11a illustrates an alternative cartridge design which uses an additional rehydration chamber 46 to rehydrate an R1 reagent (R1-X). In operation, the buffer chamber 10 and the rehydration chamber 46 can be filled from a stored buffer reservoir (not shown) that can be located at a smaller radial location than chambers 10 and 46, i.e. closer to the centre of rotation 25. Once these chambers are filled with buffer, the remainder of the assay sequence can proceed in two ways.

Firstly, the buffer volume can be delivered from the buffer chamber 10 to the reaction chamber 15 where it fills Zone A under centrifugal force. At this point, an optical measure or blank can be taken of the buffer volume in the cuvette 45. Sample is then delivered from the sample chamber 35 to the reaction chamber 15 under centrifugal force where it mixes with the buffer volume already contained in Zone A. A sample measurement can be taken at this point.

The rehydrated reagent R1-X can then be delivered from the rehydration chamber 46 to the reaction chamber 15 to mix with the diluted sample and buffer volume already present in Zone A. The cartridge 5 is then aligned to allow the fluid within Zone A to flow to Zone B under gravity if a secondary R1 reagent is present. This rehydration can be aided by mixing/agitation. When fully rehydrated, centrifugal force is used to move the sample, buffer and R1 suspension back to the cuvette 45 (Zone A) where a calibration measurement can be performed on this suspension.

The cartridge 5 is then orientated to allow the fluid to flow from the cuvette 45 to Zone C where the R2 reagent(s) are wetted by the buffer, sample and R1 suspension. Again, rehydration continues for a defined period of time until both dried reagents are fully rehydrated. The rehydration can again be aided by mixing agitation on the cartridge 5. Finally, the entire fluid volume is returned to the cuvette 45 (Zone A) where the final reaction can be monitored.

Secondly/alternatively, the above sequence can be altered such that the rehydrated R1-X volume can be delivered from the rehydration chamber 46 to the reaction chamber 15 before the buffer or sample. This allows for a reagent blank to be measured optically in the cuvette 45 prior to further dilution with buffer or the addition of sample. The advantages of this method are:
Reagent R1-X can be rehydrated in parallel with other assay processes such as blank measurement, sample/buffer delivery reducing the total assay time.
Alternatively, the rehydrated R1-X may be delivered prior to sample allowing for a reagent blank measurement. This can be advantageous as a control for reagents sensitive to storage conditions.

FIG. 11b illustrates one embodiment of the cartridge design of the embodiment of FIG. 11a which uses an additional rehydration chamber to rehydrate a R1 reagent (R1-X). This embodiment is used to perform a glycated haemoglobin (HbA1c) assay but can equally be adapted for other such immunoturbidimetric assays or an enzyme-based clinical chemistry assay. The sample is loaded into the sample chamber 35 and the buffer is loaded into buffer chamber 10. It will be appreciated that the sample could be delivered using a sample applicator and the buffer chamber could be a stored buffer reservoir.

Using centrifugal force, the sample in chamber 35 is delivered to a sample metering chamber 54, where a pre-defined sample volume required for the test is metered. In parallel, centrifugal force is also used to deliver an aliquot of buffer from chamber 10 to a first buffer metering chamber 52. Subsequently, a second aliquot of buffer is delivered to a second buffer metering chamber 53 and the excess of buffer from chamber 10 is delivered to an overflow metering chamber 58. Chamber 58 can be used as a procedural control to determine if buffer has been delivered to chambers 52, 53 and 58.

The buffer siphons in the first buffer metering chamber 52 and the second buffer metering chamber 53 are then primed using an acceleration profile provided by the motor attached to the cartridge at 25. These accelerated primed siphons do not require hydrophilic coatings to function. When the buffer siphons are primed, centrifugal force is used to move the buffer in the first buffer metering chamber 52 downstream to a sample mixing chamber 55 and in parallel move the buffer in the second buffer metering chamber 53 to the rehydration chamber 46. A suction effect is then used to transfer the sample aliquot from the sample metering chamber 54 into the sample mixing chamber 55 after the buffer aliquot from the first buffer metering chamber 52 has been delivered.

Sample and buffer are then mixed in the sample mixing chamber 55 to lyse the sample (for HbA1c) and homogenise the dilution. Other assays require the use of plasma instead of whole blood (as required for HbA1c) and the lysis step would not be required in this case. In parallel to sample mixing, the R1-X reagent in the rehydration chamber 46 is rehydrated by the buffer aliquot from the second buffer metering chamber 53.

The next operation in the cartridge is to prime the siphon exiting the sample mixing chamber 55 (on its left hand side) using an acceleration profile from the motor. This transfers the dilution downstream to the diluted sample metering chamber 56 where an aliquot of this dilution is metered. The excess of this dilution is also transferred to a reaction chamber 57 where it can be used as a procedural control to ensure sufficient sample has been delivered and/or to monitor a reaction after reagent R3 (if required) has been rehydrated.

A final acceleration profile from the motor is used to prime the siphon exiting the diluted sample metering chamber 56 and in parallel the siphon exiting the rehydration chamber 46. Using centrifugal force, the metered volume of the diluted sample from the diluted sample metering chamber 56 and the rehydrated reagent dilution from the rehydration chamber 46 are delivered simultaneously to the reaction chamber 15. This final dilution is then homogenised using a mixing profile from the motor in Zone A and an optical measurement of sample and R1-X is taken from the optical cuvette 45. A secondary reagent R1 in Zone B can also be rehydrated and mixed with this dilution. Similarly reagent R1-X could be placed at R1 and rehydrated in the reaction chamber 15 instead. For a HbA1c test this corresponds to the lysed sample being mixed with latex beads (R1-X and/or R1).

The cartridge 5 is then orientated to allow the fluid to flow from the cuvette 45 (and sitting in Zone A and B) to Zone C where the R2 reagent(s) are wetted by the buffer, sample and R1-X (and/or R1) suspension. Again, rehydration continues for a defined period of time until the reagents are fully rehydrated. The rehydration can again be aided by mixing agitation on the cartridge 5. Finally, the entire fluid volume is returned to the cuvette 45 (Zone A) using centrifugal force where the final reaction can be monitored. For the HbA1c test, this corresponds to the antibody complex reagents being rehydrated by the dilution of the lysed sample and latex beads. This agglutination phase is then optically monitored at cuvette 45.

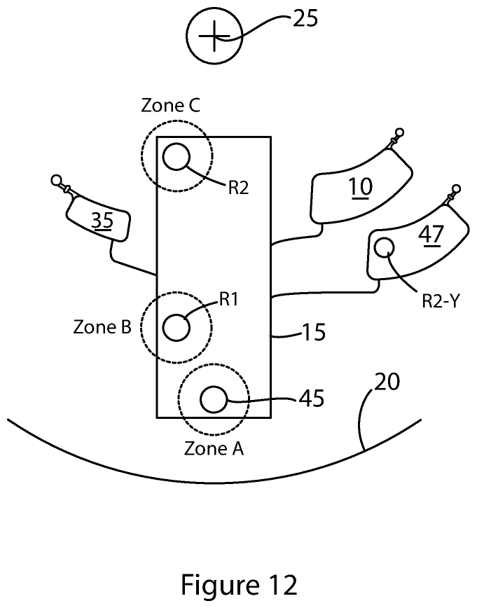

FIG. 12 illustrates another cartridge design and a variation of the previously described embodiment of FIG. 11a. Similar to the rehydration chamber described in FIG. 11a, a rehydration chamber 47 as shown contains a dried reagent R2-Y. In operation, the buffer chamber 10 and the rehydration chamber 46 can be filled from a stored buffer reservoir (not shown) that can be located at a smaller radial location than chambers 10 and 46, i.e. closer to the centre of rotation 25.

The buffer volume can be delivered from the buffer chamber 10 to the reaction chamber 15 where it fills Zone A under centrifugal force. At this point, an optical measure or blank can be taken of the buffer volume in the cuvette 45. The sample is then delivered from the sample chamber 35 to the reaction chamber 15 under centrifugal force where it mixes with the buffer volume already contained in Zone A. A sample measurement can be taken at this point.

The cartridge 5 is then aligned to allow the fluid within Zone A to flow to Zone B under gravity where reagent R1 is present and can be rehydrated. This rehydration can be aided by mixing/agitation. When fully rehydrated, centrifugal force is used to move the sample, buffer and R1 suspension back to the cuvette 45 (Zone A) where a calibration measurement can be performed on this suspension.

The rehydrated R2-Y volume can then be delivered from the rehydration chamber 47 to the reaction chamber 15 where it can be mixed with the buffer/sample/R1 suspension already present in the reaction chamber. Mixing of these volumes can be further enhanced by centrifugal or gravitational means before the mixed suspension is returned to Zone A where the endpoint reaction can be monitored in the cuvette 45. The advantage of this embodiment is that the reagent R2-Y can be rehydrated in parallel with other assay processes such as blank measurement, sample/buffer delivery and R1 rehydration, thus reducing the total assay time.

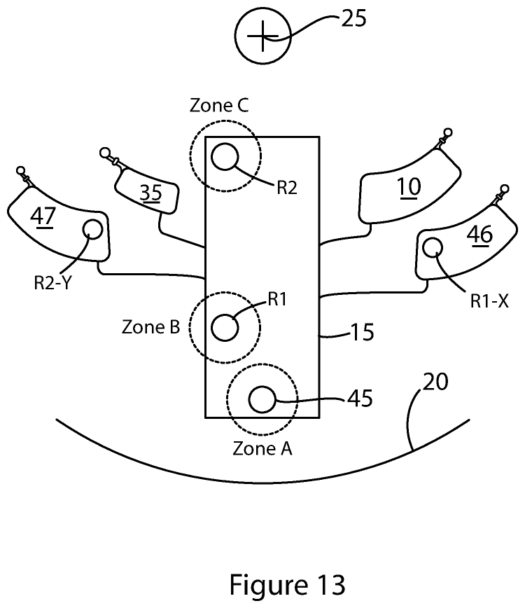

FIG. 13 illustrates another cartridge design and a variation of the previously described embodiment of FIGS. 11a and 12. Similar to the rehydration chamber described in FIG. 11a, the rehydration chamber 46 as shown contains a dried reagent R1-X and the rehydration chamber 47 as shown contains a dried reagent R2-Y. In operation, the buffer chamber 10 and the rehydration chambers 46 and 47 can be filled from a stored buffer reservoir (not shown) that can be located at a smaller radial location than chambers 10 and 46, i.e. closer to the centre of rotation 25.

The buffer volume can be delivered from the buffer chamber 10 to the reaction chamber 15 where it fills Zone A under centrifugal force. At this point, an optical measure or blank can be taken of the buffer volume in the cuvette 45. The sample is then delivered from the sample chamber 35 to the reaction chamber 15 under centrifugal force where it mixes with the buffer volume already contained in Zone A. A sample measurement can be taken at this point. In parallel to the above steps, the reagents R1-X and R1-Y have been fully rehydrated in their respective chambers 46 and 47.

The rehydrated reagent R1-X can then be delivered from the rehydration chamber 46 to the reaction chamber 15 to mix with the diluted sample and buffer volume already present in Zone A. The cartridge 5 is then aligned to allow the fluid within Zone A to flow to Zone B under gravity if a secondary R1 reagent is present. This rehydration can be aided by mixing/agitation. When fully rehydrated, centrifugal force is used to move the sample, buffer and R1 suspension back to the cuvette 45 (Zone A) where a calibration measurement can be performed on this suspension.

The rehydrated R2-Y volume can then be delivered form the rehydration chamber 47 to the reaction chamber 15 where it can be mixed with the buffer/sample/R1 suspension already present in the reaction chamber. If present, a secondary R2 reagent can be rehydrated in Zone C at this point. Mixing of these volumes can be further enhanced by centrifugal or gravitational means before the mixed suspension is returned to Zone A where the endpoint reaction can be monitored in the cuvette 45. The advantages of this embodiment are:
Reagent R1-X can be rehydrated in parallel with other assay processes such as blank measurement and sample/buffer delivery, thus reducing the total assay time.
Reagent R2-Y can be rehydrated in parallel with other assay processes such as blank measurement, sample/buffer delivery and R1 rehydration, thus reducing the total assay time.

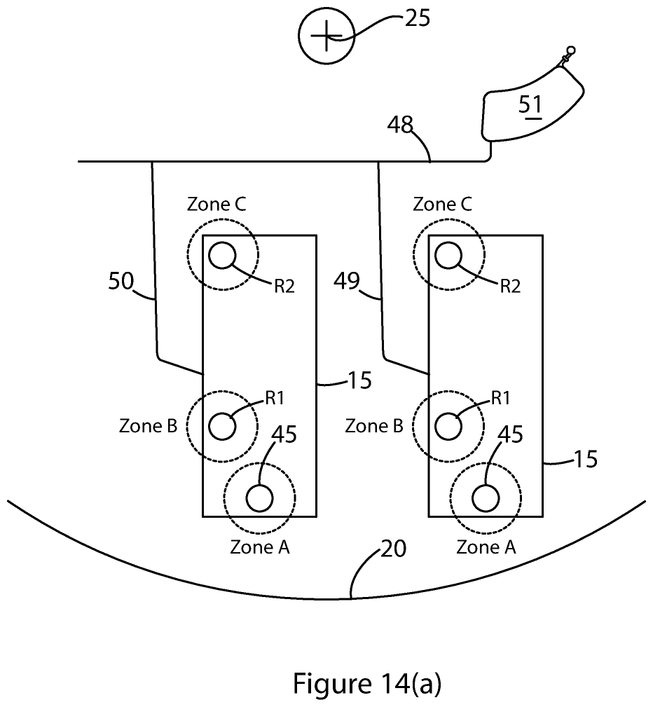

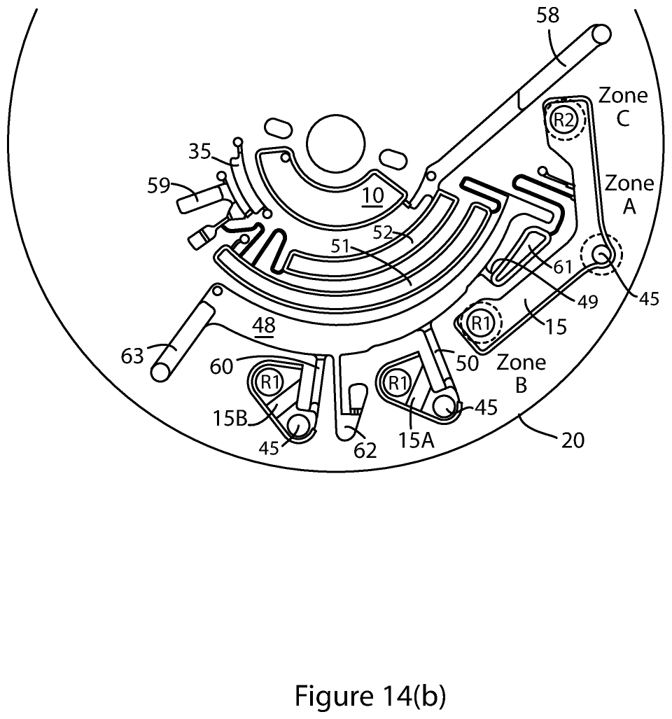

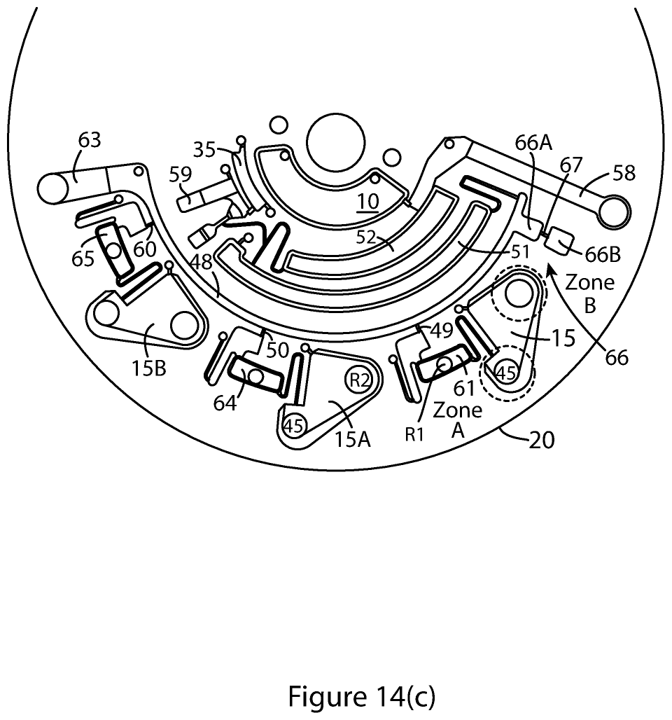

FIG. 14a illustrates a further variation of the present invention. Shown are a sample dilution chamber 51 and a plurality of reaction chambers 15 (two are shown). Although not shown in the figure, it should be understood that a sample chamber 35 and a buffer chamber 10 can be present radially inward of the dilution chamber 51. Once the sample has been diluted, it can be delivered through a distribution channel 48 to each reaction chamber 15, 15A, 15B etc. It should be understood that two or more separate reaction chambers can be present per cartridge. The diluted sample is delivered to each sequential reaction chamber via individual delivery channels 49, 50.

As the diluted sample is delivered to each reaction chamber under centrifugal force, Zone A is filled where a sample measurement can be performed in the cuvette 45. The cartridge 5 is then aligned to allow the fluid within Zone A to flow to Zone B under gravity (aided by gentle agitation if required). The sample and buffer suspension wets reagent R1 and begins rehydrating it. The rehydration continues for a defined period of time until full rehydration has been achieved. This rehydration can be aided by mixing/agitation. When fully rehydrated, centrifugal force is used to move the sample, buffer and R1 suspension back to the cuvette 45 (Zone A) where a calibration measurement can be performed on this suspension.

Similar to the rehydration of reagent R1, the cartridge 5 is then orientated to allow the fluid to flow from the cuvette 45 to Zone C where the R2 reagent(s) are wetted by the buffer, sample and R1 suspension. Again, rehydration continues for a defined period of time until both dried reagents are fully rehydrated. The rehydration can again be aided by mixing agitation on the cartridge 5. Finally, the entire fluid volume is returned to the cuvette 45 (Zone A) where the final reaction can be monitored. It is worth noting that reagents R1 and/or R2 can be spotted in singular or multiple spots. The advantage of this embodiment is that a multiplexed assay can be performed on a single cartridge in isolated reaction chambers preventing the risk of cross contamination.

FIG. 14b illustrates one embodiment of the cartridge design of the embodiment of FIG. 14a. This embodiment is used to perform a triplex of immunoturbidimetric or enzyme-based clinical chemistry assays. The sample is loaded into the sample chamber 35 and the buffer is loaded into the buffer chamber 10. It will be appreciated that the sample could be delivered using a sample applicator and the buffer chamber could be a stored buffer reservoir.

Using centrifugal force, the sample in chamber 35 is delivered to a plasma separation and metering chamber 59, where a pre-defined blood sample volume is first metered. In parallel this centrifugal force is used to deliver an aliquot of buffer from chamber 10 into the first buffer metering chamber 52 and the excess of buffer from chamber 10 is delivered to the overflow metering chamber 58. Chamber 58 can be used as a procedural control to determine if buffer has been delivered to chambers 52 and 58. The centrifugal force is then increased to separate the cellular components from the plasma in the plasma separation and metering chamber 59.

The plasma siphon exiting the plasma separation and metering chamber 59 and the buffer siphon exiting the first buffer metering chamber 52 are then primed using an acceleration profile provided by the motor attached to the cartridge at 25. When the siphons are primed, centrifugal force is used to move the metered plasma from the plasma separation and metering 59 and the metered buffer from the first buffer metering 52 downstream to the sample dilution chamber 51 where the plasma and diluent is mixed.

Once the sample has been diluted and mixed, it is delivered downstream through a distribution channel 48 to each reaction chamber 15, 15A, and 15B and to a buffering chamber 62, which prevents cross-contamination between 15A and 15B, and an overflow chamber 63. It should be understood that two or more separate reaction chambers can be present per cartridge. The diluted sample is delivered to each sequential reaction chamber via individual delivery channels 49, 50 and 60. Between the delivery channel 49 and the reaction chamber 15, there is an intermediate sample metering chamber 61 which is used to prevent cross-contamination between reaction chamber 15, 15A and 15B. The siphon connecting the intermediate sample metering chamber 61 and reaction chamber 15 is primed using an acceleration profile provided by the motor and the metered sample is then delivered to the reaction chamber 15 using centrifugal force.

This diluted sample volume fills cuvette 45 (Zone A) in reaction chambers 15, 15A and 15B respectively and an individual blank measurement can be performed in each. During the diluted sample delivery steps, the centrifugal force ensures that no fluid reaches Zone B or Zone C (in reaction chamber 15 only) and the dried reagents remain intact until R1 and R2 (in reaction chamber 15 only) are to be rehydrated.

The cartridge is then aligned to allow the fluid within Zone A to flow to Zone B under gravity (aided by gentle agitation if required) in reaction chambers 15, 15A and 15B. The diluted sample wets reagent R1 in all three reaction chambers 15, 15A and 15B and begins rehydrating them in parallel. The rehydration continues for a defined period of time until full rehydration has been achieved. This rehydration can be aided by mixing/agitation. When fully rehydrated, centrifugal force is used to move the diluted sample and R1 suspension back to the cuvette 45 (Zone A) where measurements can be performed on these suspensions.

For two-phase reactions that contain a second reagent R2, as shown in reaction chamber 15 only, the cartridge is then orientated to allow the fluid to flow from the cuvette 45 to Zone C where the R2 reagent is wetted by the diluted sample and R1 suspension. Again, rehydration continues for a defined period of time the R2 reagent is fully rehydrated. The rehydration can again be aided by mixing agitation on the cartridge. Finally, the entire fluid volume is returned to the cuvette 45 (Zone A) in reaction chamber 15 where the final two-phase reaction can be monitored. Reagents R1 and/or R2 can be spotted in singular or multiple spots.

FIG. 14c illustrates another embodiment of the cartridge design of the embodiment of FIG. 14a. This embodiment, similar to FIG. 14b, is used to perform a triplex of immunoturbidimetric or enzyme-based clinical chemistry assays. The sample is loaded into sample chamber 35 and buffer is loaded into buffer chamber 10. It will be appreciated that the sample could be delivered using a sample applicator and the buffer chamber could be a stored buffer reservoir.

Using centrifugal force, the sample in chamber 35 is delivered to the plasma separation and metering chamber 59, where a pre-defined blood sample volume is first metered. In parallel this centrifugal force is used to deliver an aliquot of buffer from chamber 10 into the first buffer metering chamber 52 and the excess of buffer from chamber 10 is delivered to the overflow metering chamber 58. Chamber 58 can be used as a procedural control to determine if buffer has been delivered to chambers 52 and 58. The centrifugal force is then increased to separate the cellular components from the plasma in the plasma separation and metering chamber 59.

The buffer siphon exiting the first buffer metering chamber 52 is then primed using an acceleration profile provided by the motor attached to the cartridge at 25. This accelerated primed siphon does not require a hydrophilic coatings to function. When the buffer siphon is primed, centrifugal force is used to move the metered buffer from the first buffer metering 52 downstream to the sample dilution chamber 51. A suction effect is then used to transfer the plasma volume downstream from the plasma separation and metering chamber 59 into the sample dilution chamber 51 where the plasma and diluent is mixed.

Once the sample has been diluted and mixed, it is delivered downstream through a distribution channel 48 sequentially to a buffering chamber 66, reaction chamber 15, 15A, and 15B and to the sample dilution overflow chamber 63. It should be understood that two or more separate reaction chambers can be present per cartridge. Buffering chamber 66 is placed at the beginning of the distribution channel 48 to ensure non-homogeneous diluted sample flows in here instead of into the reaction chambers 15, 15A and 15B. The buffering chamber comprises a first section 66a and a second section 66b linked by a capillary channel 67. The diluted sample passes through a delivery channel 49 using centrifugal force and into the first intermediate chamber 61 which contains a metering chamber and an overflow chamber. The metering chamber is filled with diluted sample first before the overflow fills and blocks its vent. The pressure in the overflow chamber will then increase and the diluted sample flow through delivery channel 49 will stop when the centrifugal pressure being applied to the delivery channel 49 is equal to the pressure in the overflow chamber. When the diluted sample stops flowing through the delivery channel 49, a second intermediate chamber 64 is filled in the same way through delivery channel 50. A third intermediate channel 65 is filled in the same manner through the delivery channel 60 prior to the remaining diluted sample being transferred to the overflow chamber 63 via the distribution channel 48.

When all of the diluted sample is delivered from the sample dilution chamber 51, the centrifugal force produced by the motor is increased to break the capillary channel 67 in the buffering chamber 66 so that the diluted sample passes radially outward from the first section 66a to the second section 66b. In parallel the centrifugal pressure in delivery channels 49, 50 and 60 will increase and the diluted sample remaining in these channels will be flushed out and the pressure in the overflow chambers of the first, second and third intermediate chambers, 61, 64 and 65 respectively will return to normal atmospheric pressure. This allows the downstream fluidics to operate as expected and ensure the transfer of fluids from 61 to 15, 64 to 15A and 65 to 15B when required.

For two-phase assays, a first reagent R1 can be placed in the first, second and third intermediate chambers 61, 64 and 65 and these dried reagents are rehydrated by the metered volumes of diluted sample. An acceleration profile from the motor is then used to transfer this dilution from the first, second and third intermediate chambers 61, 64 and 65 via their exit siphons to the reaction chambers 15, 15A and 15B downstream. This dilution volume fills cuvette 45 (Zone A) in reaction chambers 15, 15A and 15B respectively and an individual blank measurement can be performed in each. During the dilution delivery steps, the centrifugal force ensures that no fluid reaches Zone B in the reaction chambers 15, 15A and 15B and the dried reagents in Zone B (first or second reagents R1, R2) remain intact until they are to be rehydrated.

The cartridge is then aligned to allow the fluid within Zone A to flow to Zone B under gravity (aided by gentle agitation if required) in reaction chambers 15, 15A and 15B. The dilution wets these reagents in all 3 reaction chambers 15, 15A and 15B and begins rehydrating them in parallel. The rehydration continues for a defined period of time until full rehydration has been achieved. This rehydration can be aided by mixing/agitation. When fully rehydrated, centrifugal force is used to move this dilution back to the cuvette 45 (Zone A) where measurements can be performed on these suspensions.

It will be appreciated from the above description that microfluidic system of the present invention is suitable for performing any type of immunoturbidimetric and enzyme-based clinical chemistry assay. Furthermore, the microfluidic system of the present invention is very flexible, as it can be used to perform an assay that requires the addition and rehydration of a single reagent, as well as to perform an assay that requires the addition and rehydration of multiple reagents. This is due to the fact that the second and/or third reagent zones of the cartridge can each be provided with multiple reagent spots.

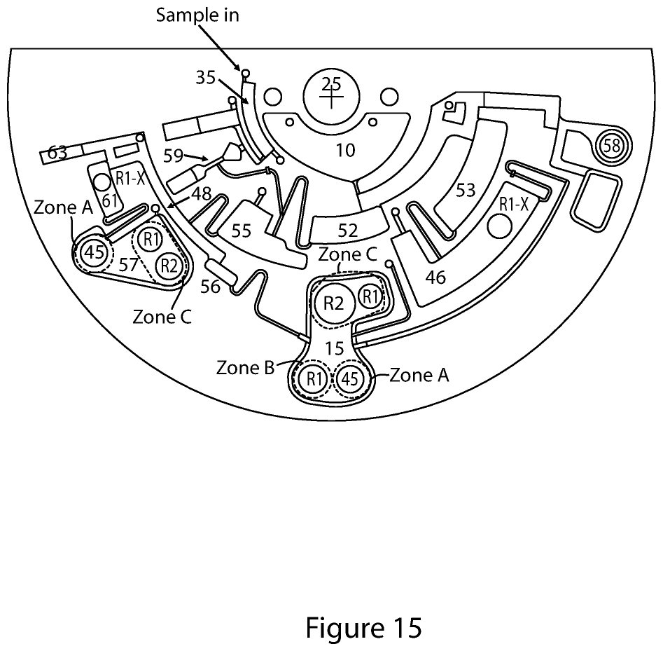

FIG. 15 illustrates another cartridge design and a variation of the described embodiments of FIG. 11b and FIG. 14c. This embodiment in FIG. 15 is used to perform 2 immunoturbidimetric assays or 2 enzyme-based clinical chemistry assays or a combination of these in parallel. This cartridge embodiment has a serial dilution step which provides 2 different sample-diluent ratios and facilitates the testing of 2 different analytes in parallel which separately have low (e.g. ferritin) and high concentration (e.g. C-reactive protein) levels in the sample. The sample is loaded into the sample chamber 35 and the buffer is loaded into buffer chamber 10. It will be appreciated that the sample could be delivered using a sample applicator and the buffer chamber could be a stored buffer reservoir.

Using centrifugal force, the sample in chamber 35 is delivered to a plasma separation and sample metering chamber 59, where a pre-defined sample volume required for the test is metered and then the cellular components are separated from the plasma. In parallel this centrifugal force is also used to deliver an aliquot of buffer from chamber 10 to a first buffer metering chamber 52. Subsequently, a second aliquot of buffer is delivered to a second buffer metering chamber 53 and the excess of buffer from chamber 10 is delivered to an overflow metering chamber 58. Chamber 58 can be used as a procedural control to determine if buffer has been delivered to chambers 52, 53 and 58.

The buffer siphons exiting the first buffer metering chamber 52 and the second buffer metering chamber 53 are then primed using an acceleration profile provided by the motor attached to the cartridge at 25. These accelerated primed siphons do not require hydrophilic coatings to function. When the buffer siphons are primed, centrifugal force is used to move the buffer in the first buffer metering chamber 52 downstream to a sample mixing chamber 55 and in parallel move the buffer in the second buffer metering chamber 53 to the rehydration chamber 46. A suction effect is then used to transfer the separated plasma from the plasma separation and metering chamber 59 into the sample mixing chamber 55 after the buffer aliquot from the first buffer metering chamber 52 has been delivered.

Plasma and buffer are then mixed in the sample mixing chamber 55 to homogenise this first sample-diluent mixture. In parallel to sample mixing, if an R1-X reagent is located in the rehydration chamber 46, this is rehydrated by the buffer aliquot from the second buffer metering chamber 53.

The next operation in the cartridge is to prime the siphon exiting the sample mixing chamber 55 (on its left hand side) using an acceleration profile from the motor. This transfers the first sample-diluent mixture downstream through a distribution channel 48 sequentially to a diluted sample metering chamber 56, to the intermediate metering chamber 61 (before the mixture is transferred to the reaction chamber 57) and finally to the sample dilution overflow chamber 63. From the FIG. 14b and FIG. 14c embodiments, a further embodiment would be to extend the distribution channel 48 to deliver to additional reaction chambers (57A, 57B . . . ) to expand the number of assays tested on the cartridge. For two-phase assays, a first reagent R1-X can be placed in the intermediate metering chamber 61 if required and the dried reagent is rehydrated by the metered volume of diluted sample.

A final acceleration profile from the motor is used to prime in parallel the siphons exiting the diluted sample metering chamber 56, the intermediate metering chamber 61 and the rehydration chamber 46. Then using centrifugal force, the first sample-diluent mixture from the diluted sample metering chamber 56 and the volume from the rehydration chamber 46 are delivered simultaneously to the reaction chamber 15. In parallel the centrifugal force transfers the volume in the intermediate metering chamber 61 into the reaction chamber 57. The second sample-diluent mixture in reaction chamber 15 is then homogenised using a mixing profile from the motor in Zone A and an optical measurement is taken from the optical cuvette 45. A reagent R1 in Zone B of reaction chamber 15 can also be rehydrated and mixed with this dilution. In parallel the first sample-diluent mixture in reaction chamber 57 will be mixed again and if a reagent is in place in Zone A then this will also be homogenised also.

The cartridge 5 is then orientated to allow the fluid to flow from the cuvette 45 in reaction chamber 15 (and sitting in Zone A and B) to Zone C where the R1 (if located here instead) and R2 reagent(s) are wetted by the second sample-diluent mixture. In parallel the fluid in cuvette 45 in reaction chamber 57 (sitting in Zone A) is transferred to Zone C where the R1 and R2 reagent(s) are wetted by the first sample-diluent mixture. Again, rehydration continues for a defined period of time until the reagents are fully rehydrated. The rehydration can again be aided by mixing/agitation on the cartridge 5. Finally, the entire fluid volumes in reaction chambers 15 and 57 are returned to their cuvettes 45 (Zone A) using centrifugal force where the final reactions can be monitored. For immunoturbidimetric tests such as ferritin, C-reactive protein (CRP), Vitamin D and apolipoprotein B (apo B) this is the monitoring of the agglutination phase of their reactions.

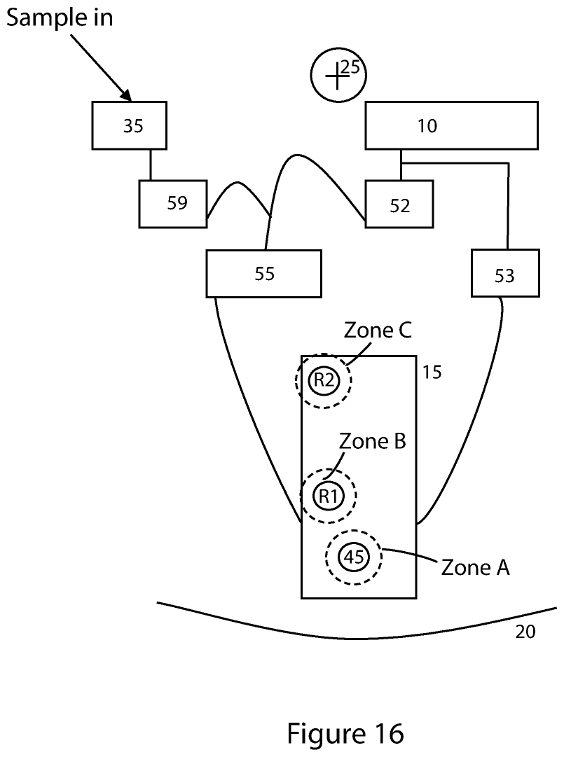

FIG. 16 illustrates another cartridge design and a variation of the described embodiments of FIG. 11b, FIG. 14c and FIG. 15. This embodiment in FIG. 16 is used to perform a single immunoturbidimetric assay or enzyme-based clinical chemistry assay. This cartridge embodiment has a serial dilution step which provides a first sample-diluent mixture and in parallel rehydrates the reagents with buffer only before they are homogenised together in the reaction chamber 15. In laboratory analyser immunoturbidimetric tests (liquid) such as ferritin, CRP, Vitamin D, or apo B, the assay reagents are first mixed with buffer to create a reagent blank before this is homongenised with sample. This is a point of care embodiment of this where the dried reagents are first rehydrated with buffer.

The sample is loaded into the sample chamber 35 and the buffer is loaded into buffer chamber 10. It will be appreciated that the sample could be delivered using a sample applicator and the buffer chamber could be a stored buffer reservoir.

Using centrifugal force, the sample in chamber 35 is delivered to a plasma separation and sample metering chamber 59, where a pre-defined sample volume required for the test is metered and then the cellular components are separated from the plasma. In parallel this centrifugal force is also used to deliver an aliquot of buffer from chamber 10 to a first buffer metering chamber 52. Subsequently, a second aliquot of buffer is delivered to a second buffer metering chamber 53.

The buffer siphons exiting the first buffer metering chamber 52 and the second buffer metering chamber 53 are then primed using an acceleration profile provided by the motor attached to the cartridge at 25. These accelerated primed siphons do not require hydrophilic coatings to function. When the buffer siphons are primed, centrifugal force is used to move the buffer in the first buffer metering chamber 52 downstream to a sample mixing chamber 55 and in parallel move the buffer in the second buffer metering chamber 53 to the reaction chamber 15. A suction effect is then used to transfer the separated plasma from the plasma separation and metering chamber 59 into the sample mixing chamber 55 after the buffer aliquot from the first buffer metering chamber 52 has been delivered.

Plasma and buffer are then mixed in the sample mixing chamber 55 to homogenise this first sample-diluent mixture. In parallel to sample mixing, the reagents R1 (Zone B) and R2 (Zone C) in the reaction chamber 15 will be rehydrated with the buffer from the second buffer metering chamber 53.

The final operation of the cartridge is to prime the siphon exiting the sample mixing chamber 55 using an acceleration profile from the motor. This transfers the first sample-diluent mixture to the reaction chamber 15 where it is then homogenised with the rehydrated reagents mixture and the final (agglutination) reaction is monitored at cuvette 45.

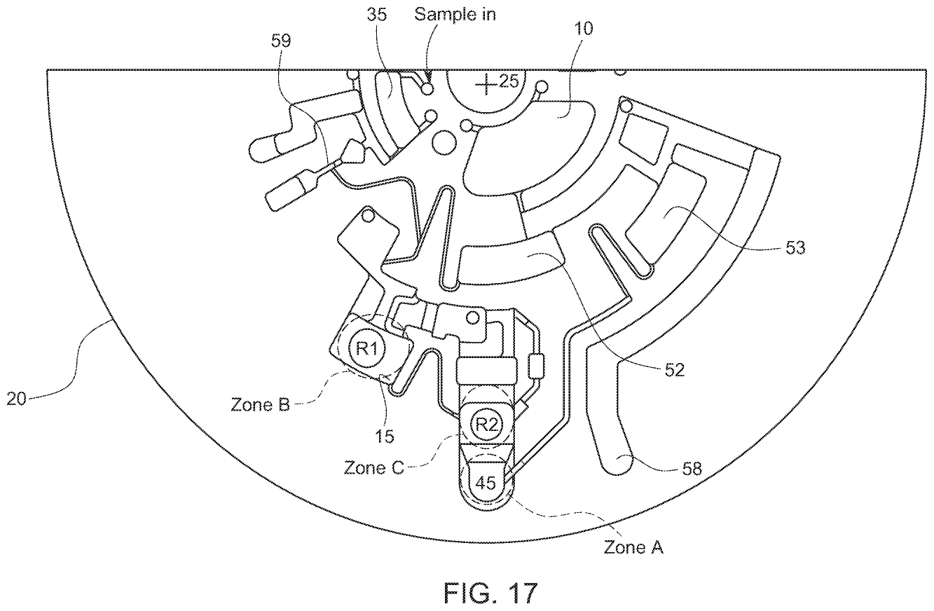

FIG. 17 illustrates another cartridge design 20 and a variation of the described embodiment of FIG. 16. This embodiment in FIG. 17 is used to perform a single immunoturbidimetric assay or enzyme-based clinical chemistry assay. This cartridge embodiment has a serial dilution step which provides a first sample-diluent mixture which rehydrates a first reagent R1. In parallel an aliquot of buffer rehydrates a second reagent R2 before the rehydrated reagent R1 (with first sample-diluent mixture) and rehydrated reagent R2 (with buffer) are homogenised together in a reaction chamber 15. This reaction volume is a second, more dilute, plasma-diluent mixture.

In laboratory analyser immunoturbidimetric tests (liquid) such as ferritin, CRP, Vitamin D or apo B the assay reagents are first mixed with buffer to create a reagent blank before this is homogenised with sample. This is a point of care embodiment of this where the dried reagents are first rehydrated with sample-diluent and buffer respectively.

The sample is loaded into the sample chamber 35 and the buffer is loaded into buffer chamber 10. It will be appreciated that the sample could be delivered using a sample applicator and the buffer chamber could be a stored buffer reservoir.

Using centrifugal force, the sample in chamber 35 is delivered to a plasma separation and sample metering chamber 59, where a pre-defined sample volume required for the test is metered and then the cellular components are separated from the plasma. In parallel, centrifugal force is also used to deliver an aliquot of buffer from chamber 10 to a first buffer metering chamber 52. Subsequently, a second aliquot of buffer is delivered to a second buffer metering chamber 53 and the remaining buffer is transferred to an overflow region 58.

The buffer siphons exiting the first buffer metering chamber 52 and the second buffer metering chamber 53 are then primed using an acceleration profile provided by the motor attached to the cartridge at 25. These accelerated primed siphons do not require hydrophilic coatings to function. When the buffer siphons are primed, centrifugal force is used to move the buffer in the first buffer metering chamber 52 downstream to Zone B through a channel entering the top left of the reaction chamber 15. In parallel, the buffer in the second buffer metering chamber 53 moves to Zone A in the right side of the reaction chamber 15. A suction effect is then used to transfer the separated plasma from the plasma separation and metering chamber 59 into Zone B of the reaction chamber 15 after the buffer aliquot from the first buffer metering chamber 52 has been delivered to Zone B.

Plasma and buffer are then used to first rehydrate reagent R1 in Zone B of the reaction chamber 15 and then this sample-diluent-R1 mixture is homogenised in Zone B. In parallel, the buffer in Zone A is transferred to Zone C of the reaction chamber 15 and the reagent R2 is rehydrated and homogenised. This buffer-R2 mixture is then returned to the cuvette 45 in Zone A of the reaction chamber 15 using centrifugal force.

The final operation of the cartridge is to prime the siphon connecting Zone B and Zone C of the reaction chamber 15 using an acceleration profile from the motor. This transfers the sample-diluent-R1 mixture in Zone B to the cuvette 45 in Zone A, via Zone C, of the reaction chamber 15 where it is then homogenised with the buffer-R2 mixture and the final (agglutination) reaction is monitored in cuvette 45.

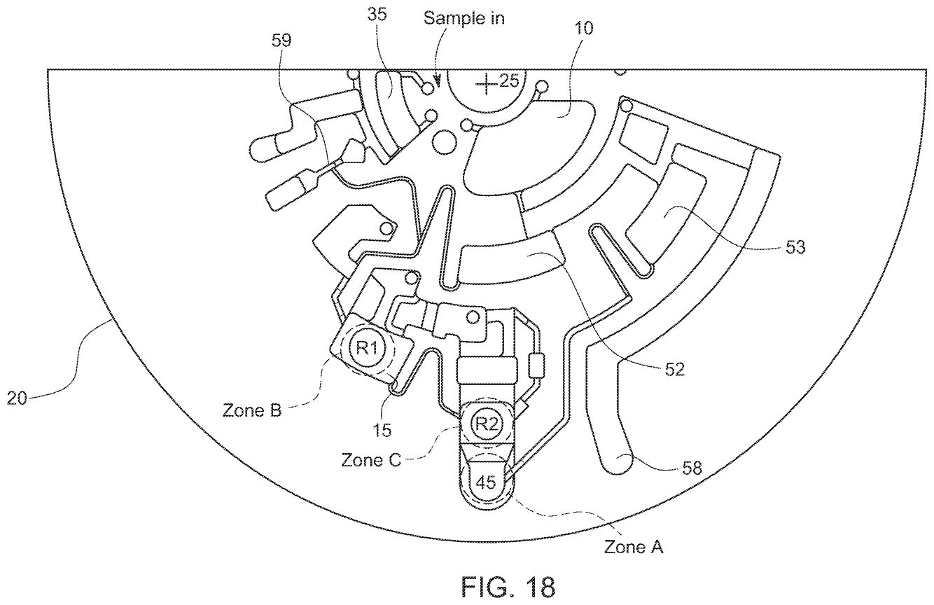

FIG. 18 illustrates another cartridge design 20 and a variation of the described embodiment of FIG. 16. The functionality of this embodiment is the same as that of FIG. 17, but it has a slightly different structure. As was the case with the embodiment of FIG. 17, the embodiment of FIG. 18 is used to perform a single immunoturbidimetric assay or enzyme-based clinical chemistry assay. Thus, in the same manner as FIG. 17, this embodiment also has a serial dilution step which provides a first sample-diluent mixture which rehydrates a first reagent R1, while in parallel an aliquot of buffer rehydrates a second reagent R2 before the rehydrated reagent R1 (with first sample-diluent mixture) and rehydrated reagent R2 (with buffer) are homogenised together in a reaction chamber 15. This reaction volume is a second, more dilute, plasma-diluent mixture.

The sample is loaded into the sample chamber 35 and the buffer is loaded into buffer chamber 10. It will be appreciated that the sample could be delivered using a sample applicator and the buffer chamber could be a stored buffer reservoir.

Using centrifugal force, the sample in chamber 35 is delivered to a plasma separation and sample metering chamber 59, where a pre-defined sample volume required for the test is metered and then the cellular components are separated from the plasma. In parallel, centrifugal force is also used to deliver an aliquot of buffer from chamber 10 to a first buffer metering chamber 52. Subsequently, a second aliquot of buffer is delivered to a second buffer metering chamber 53 and the remaining buffer is transferred to an overflow region 58.

The buffer siphons exiting the first buffer metering chamber 52 and the second buffer metering chamber 53 are then primed using an acceleration profile provided by the motor attached to the cartridge at 25. These accelerated primed siphons do not require hydrophilic coatings to function. When the buffer siphons are primed, centrifugal force is used to move the buffer in the first buffer metering chamber 52 downstream directly to Zone B in the reaction chamber 15. In parallel, the buffer in the second buffer metering chamber 53 moves to Zone A in the right side of the reaction chamber 15. A suction effect is then used to transfer the separated plasma from the plasma separation and metering chamber 59 into Zone B of the reaction chamber 15 after the buffer aliquot from the first buffer metering chamber 52 has been delivered to Zone B.

Plasma and buffer are then used to first rehydrate reagent R1 in Zone B of the reaction chamber 15 and then this sample-diluent-R1 mixture is homogenised in Zone B. In parallel, the buffer in Zone A is transferred to Zone C of the reaction chamber 15 and the reagent R2 is rehydrated and homogenised. This buffer-R2 mixture is then returned to the cuvette 45 in Zone A of the reaction chamber 15 using centrifugal force.

The final operation of the cartridge is to prime the siphon connecting Zone B and Zone C of the reaction chamber 15 using an acceleration profile from the motor. This transfers the sample-diluent-R1 mixture in Zone B to the cuvette 45 in Zone A, via Zone C, of the reaction chamber 15 where it is then homogenised with the buffer-R2 mixture and the final (agglutination) reaction is monitored in cuvette 45.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A microfluidic system comprising:
a cartridge coupled to a motor and adapted to move a fluid sample to a plurality of locations on the cartridge, wherein the cartridge is configured to rotate on an inclined plane with respect to a horizontal plane;
the cartridge comprises:
a reaction chamber, the reaction chamber comprising at least a first zone comprising a single cuvette positioned adjacent to the outer diameter of the cartridge and defining a detection zone configured to allow for optical measurement of each phase of a reaction, and wherein the reaction chamber has at least three zones, the first zone positioned near one end of the reaction chamber, a second zone and a third zone, wherein each of the second zone and the third zone comprise a reagent zone, and wherein the motor and a control module is configured to provide a combination of centrifugal force and gravitational force to move said fluid sample between the at least three zones;
a sample metering chamber configured to receive the fluid sample and meter a pre-defined volume of the sample for transfer to a sample mixing chamber;
a first buffer metering chamber configured to meter a pre-defined first volume of a buffer solution for transfer to the sample mixing chamber;
wherein the sample mixing chamber is coupled to the sample metering chamber and to the first buffer metering chamber and configured to homogenise the sample volume transferred from the sample metering chamber with the first volume of buffer solution transferred from the first buffer metering chamber to create a first sample-diluent mixture; and
a second buffer metering chamber configured to meter a pre-defined second volume of the buffer solution for transfer to the reaction chamber; wherein the second volume of the buffer solution is transferred to the reaction chamber and rehydrated with at least one reagent prior to homogenisation with the first sample-diluent mixture in the reaction chamber so as to create a second sample-diluent mixture.

2. The microfluidic system as claimed in claim 1, wherein the first zone is positioned at a radial extent and at a furthest point from a centre of rotation of the reaction chamber.

3. The microfluidic system as claimed in claim 2, wherein the second zone is positioned radially inward with respect to the first zone and comprises a first reagent spot location R1.

4. The microfluidic system as claimed in claim 2, wherein the second zone is positioned at the same radius as the first zone and comprises a first reagent spot location R1.

5. The microfluidic system as claimed in claim 3, wherein the second zone is connected to the third zone by a siphon.

6. The microfluidic system as claimed in claim 3, wherein the third zone is positioned radially inward with respect to the first zone and comprises a second reagent spot location R2.

7. The microfluidic system as claimed in claim 6, wherein the first buffer solution from the first buffer metering chamber is transferred to the sample mixing chamber prior to the sample volume from the sample metering chamber being transferred to the sample mixing chamber.

8. The microfluidic system as claimed in claim 7, wherein the sample mixing chamber is coupled to the reaction chamber, and wherein the first sample-diluent mixture is transferred from the sample mixing chamber to the reaction chamber for homogenisation with the second buffer solution after the second volume of the buffer solution has been transferred to the reaction chamber and has rehydrated a first reagent in the reagent spot location R1 in the second zone of the reaction chamber and rehydrated a second reagent in the reagent spot location R2 in the third zone of the reaction chamber.

9. The microfluidic system as claimed in claim 7, wherein the sample mixing chamber is incorporated within the second zone of the reaction chamber.

10. The microfluidic system as claimed in claim 9, wherein the sample volume from the sample metering chamber and the first buffer solution from the first buffer metering chamber are transferred to the sample mixing chamber via a channel located at the top of the second zone.

11. The microfluidic system as claimed in claim 9, wherein the sample volume from the sample metering chamber and the first buffer solution from the first buffer metering chamber are transferred to the sample mixing chamber via a channel located in the side of the second zone.

12. The microfluidic system as claimed in claim 10, wherein the second volume of the buffer solution is transferred into the reaction chamber at the first zone of the reaction chamber.

13. The microfluidic system of claim 12 wherein the second volume of the buffer solution is transferred into the reaction chamber simultaneously with the transfer of the first buffer solution from the first buffer metering chamber to the sample mixing chamber.

14. The microfluidic system as claimed in claim 13, wherein a first reagent in the reagent spot location R1 in the second zone of the reaction chamber is rehydrated by the first sample diluent mixture and homogenised to form a mixture of the first sample-diluent and the first reagent prior to homogenisation with the second volume of the buffer solution in the first zone of the reaction chamber.

15. The microfluidic system as claimed in claim 14, wherein a second reagent in the reagent spot location R2 in the third zone of the reaction chamber is rehydrated by the second volume of the buffer solution and homogenised to form a mixture of the second volume of buffer solution and the second reagent prior to homogenisation with the first sample-diluent mixture in the first zone of the reaction chamber.

16. The microfluidic system of claim 15, wherein the rehydration of the first reagent in the reagent spot location R1 in the second zone of the reaction chamber is simultaneous with the rehydration of the second reagent in the reagent spot location R2 in the third zone of the reaction chamber.

17. The microfluidic system as claimed in claim 1, wherein the sample metering chamber comprises a plasma separation and sample metering chamber configured to receive the fluid sample and meter a pre-defined volume of the sample and then separate the cellular components from the plasma.

18. The microfluidic system as claimed in claim 1, further comprising a sample chamber coupled to the sample metering chamber for receiving the sample for delivery to the sample metering chamber.

19. The microfluidic system as claimed in claim 1, further comprising a buffer chamber coupled to the first buffer metering chamber and to the second buffer metering chamber for storing the buffer solution.

20. The microfluidic system as claimed in claim 19, further comprising an overflow metering chamber coupled to the buffer chamber for receiving excess buffer from the buffer chamber.

21. The microfluidic system as claimed in claim 1, wherein the cartridge is configured such that no fluid reaches the second zone or third zone when the fluid sample in the first zone is under the influence of the centrifugal force.

22. The microfluidic system as claimed in claim 1, wherein when the cartridge is configured to be stationary or rotate slowly, gravity will influence the fluid and move the fluid towards the second zone or third zone.

23. The microfluidic system as claimed in claim 1, wherein the cuvette comprises a single volume cuvette configured to allow for optical measurement of the buffer solution, the fluid sample and the rehydrated reagents used in each phase of the reaction.

24. The microfluidic system as claimed in claim 1, wherein the system is configured for performing a single immunoturbidimetric or enzyme-based clinical chemistry assay.
